(19) United States
(12) Patent Application Publication
(10) Pub. No.: US 2004/0023631 A1
(43) Pub. Date: Feb. 5, 2004

(54) Method and system for rejecting noise in information communication

(76) Inventors: Jeffrey T. Deutsch, Los Altos, CA (US); Doreen Y. Cheng, Los Altos, CA (US)

Correspondence Address: Jeffrey T. Deutsch, 941 Russell Ave., Los Altos, CA, 94024, US

(21) Appl. No.: 10/209,108

(22) Filed: Jul. 30, 2002

(51) Int. Cl. H04B 1/18

(52) U.S. Cl. 455/283; 455/296

(57) ABSTRACT

This invention provides a method and system for increasing the bandwidth and distance of communication links by enabling noise from unwanted background radiation to be effectively eliminated. This is achieved by taking advantage of the fact that background radiation has much broader frequency spectrum than information signal carriers. Spectrum of interest is divided into multiple partitions. Reference signals are constructed over the spectral partitions according to defined selection criteria so that these reference signals can be used to reduce in-band noise of desired information signal through common mode noise elimination. Using differential signaling schemes further reduces noise from non-background radiation sources in addition to noise from background radiation sources. This method is applicable to both analog and digital systems.

### FEDERALLY SPONSORED RESEARCH

Not applicable

### SEQUENCE LISTING OR PROGRAM

Not applicable

### BACKGROUND OF THE INVENTION

1. Field of the Invention

This invention relates to the field of communication especially free space communication, and in particular to effective rejection of noise from broadband background radiation.

2. Description of Related Art

Current state-of-the-art communication links, especially free-space communication links are limited by noise. Sources of noise include background radiation, such as sunlight, artificial light, and intentional jamming, and noise generated within devices, including shot noise, thermal noise, excess noise, and intensity noise. Effective rejection of unwanted noise not only increases the sensitivity of signal reception and the distance over which a communication link can function properly, but also reduces error rate and allows increased communication bandwidth. Consequently, effective rejection of unwanted noise allows the creation of more cost-effective communication systems.

This invention devises a method and system for rejecting noise from background radiation including natural and artificial emission. This invention also devises a method and system that uses differential signaling for further reducing noise originated from both background and non-background radiation.

State-of-the-art methods for rejecting background noise commonly rely on narrow bandpass filters such as Fabry-Perot interferometer based filters and heterodyne receivers. The fundamental limitation of filter-only based approaches is that they can only reject noise outside the pass-band of the filters; they cannot distinguish between signals and noises within the passband. For easy reference, noise whose frequency spectrum includes the spectrum of an information-carrying signal is referred to as in-band noise, whereas noise whose spectrum mostly falls outside of the frequency spectrum of an information-carrying signal is referred to as out-of-band noise. In a practical environment, many noise sources have radiation spectrum that overlaps with desirable information spectrum. Moreover, the bandwidth of information-carrying signals is often broadened due to unavoidable processes such as the Doppler Effect encountered along propagation paths and/or intentional processes such as modulation of carriers with information signals. Broadening of carrier bandwidth results in using wider filter bandwidth, permitting more noise to slip through band-pass filters. This in-band noise can result in communication errors and significantly reduced bandwidth. This invention alleviates the problem by not only effectively rejecting out-of-band noise but also effectively reducing in-band noise.

Many techniques have been developed to effectively reduce noises inherent to devices and circuits. These techniques, such as noise-matched system design and maximum-likelihood demodulation, and skillful circuit design and parameter tuning, minimize overall system noise; they are not, however, aimed at reject in-band background radiation noise. Techniques have also been developed to effectively reduce noises introduced along communication paths. These techniques rely on the control of the properties of carriers and the quality of propagation paths including controlling polarization, mode, and dispersion; they do not reduce noise from background radiation either.

These prior art techniques can be used together with the techniques demonstrated in this invention to improve overall system performance.

### BRIEF SUMMARY OF THE INVENTION

It is an object of this invention to provide a method and system to effectively reject noise from background radiation and noise from non-background radiation sources in communication systems. By effective rejection of noise, this invention provides three main advantages over the state-of-the art. Firstly it enables communication system to receive signals that are too weak to be received by the state-of-the-art. Secondly it increases the distance that communication links can effectively cover, and thirdly, it significantly reduces the error rate and allows increased communication bandwidth.

The object is achieved through a method and system to turn background radiation into common mode noise with respect to a desired information signal, and to reduce in-band noise of the information signal using common mode noise elimination techniques. The method takes advantage of the fact that noise from background radiation has a broad frequency spectrum compared to signal carriers. Spectrum of interest is divided into multiple partitions. Reference signals are constructed over the spectral partitions according to defined selection criteria so that these signals can be used to effectively reduce in-band noise of desired information signal through common mode noise elimination. The method further takes advantage of differential signaling schemes to reduce noise from non-background radiation sources in addition to noise from background radiation sources.

The method is applicable to both analog and digital systems. The method can be employed at various places in a receiver. As one example it is employed at initial receiving stage of a receiver. As another example it is employed at more than one place after one or more frequency conversion stages.

The embodiments of this invention are presented in two groups. A first group of embodiments demonstrates the most basic use of the method where noise in a desired information signal is eliminated independent of other desired information signal. In this group of embodiment, a receiver constructs at least one noise reference signal from the spectral partitions that are adjacent to the spectrum of desired information signal. The receiver shapes the noise reference signals so that they can be used to effectively cancel in-band noise of the information signal. Common mode noise eliminators with sufficiently high common mode rejection ratio are then used for the noise cancellation so that a signal-to-noise ratio (SNR) that satisfies system requirements can be achieved.

A second group of embodiments demonstrates examples of using differential signaling to reduce in-band noise from both signals of a differential pair, where the pair may share one noise reference signal. The first group of embodiments can be used to reject noise independently in every signal of a differential pair. However sharing devices can reduce the cost of implementation. It should be further noted that differential signaling is not a requirement for sharing a noise reference signal.

### BRIEF DESCRIPTION OF THE DRAWINGS

FIG. 1 is a preferred embodiment of an overall communication system which employs the noise-rejection method at the initial stage of a receiver, in accordance with this invention.

FIG. 1a is a preferred embodiment of a receiver which employs the noise-rejection method after a frequency conversion stage which takes electromagnetic waves as input and outputs electrical signals, in accordance with this invention.

FIG. 1b is a preferred embodiment of a receiver which employs the noise-rejection method after a frequency conversion stage whose input and output are both electromagnetic waves, in accordance with this invention.

FIG. 1c is an example embodiment of a receiver that has multiple frequency conversion stages and applies the noise-rejection method at multiple places, in accordance with this invention.

FIG. 2a shows two example embodiments of a frequency conversion stage that outputs a frequency-shifted electrical signal, in accordance with this invention.

FIG. 2b is an example embodiment of a frequency conversion stage that outputs a frequency-shifted electromagnetic wave signal, in accordance with this invention.

FIG. 3a is an example embodiment of a digital demodulator, in accordance with this invention.

FIG. 3b is an example embodiment of an analog demodulator, in accordance with this invention.

FIG. 4 is a preferred embodiment of a transmission preparation unit which prepares information input for single-ended signal transmission, in accordance with this invention.

FIG. 5a is a preferred embodiment of a receiving and preprocessing unit of a receiver where a single noise reference signal is obtained by splitting a received input signal into multiple signals, in accordance with this invention.

FIG. 5b is a preferred embodiment of a receiving and preprocessing unit of a receiver which directly receives a noise reference signal, in accordance with this invention.

FIG. 5c is a preferred embodiment of a receiving and preprocessing unit of a receiver where a heterodyne or homodyne based receiving unit is used to produce information-carrying signal, in accordance with this invention.

FIG. 6a is a preferred embodiment of a common mode noise elimination and signal conversion unit with an interference-based common mode noise eliminator that takes one information signal and one noise reference signals as input, in accordance with this invention.

FIG. 6b is a preferred embodiment of a common mode noise elimination and signal conversion unit with an interference-based common mode noise eliminator that takes one information signal and two noise reference signals as input, in accordance with this invention.

FIG. 6c is a preferred embodiment of a common mode noise elimination and signal conversion unit with an electrical common mode noise eliminator, in accordance with this invention.

FIG. 7a is a preferred embodiment of a two-input interference-based common mode noise eliminator that uses a frequency shifting unit, in accordance with this invention.

FIG. 7b is a preferred embodiment of a two-input interference-based common mode noise eliminator that uses wavelength compensation paths, in accordance with this invention.

FIG. 7c is a preferred embodiment of a three-input interference-based common mode noise eliminator that uses frequency shifting units, in accordance with this invention.

FIG. 7d is a preferred embodiment of a three-input interference-based common mode noise eliminator uses wavelength compensation paths, in accordance with this invention.

FIG. 8a is a preferred embodiment of a receiving and preprocessing unit of a receiver where a balanced noise reference signal is obtained by splitting a received input signal into multiple signals, in accordance with this invention.

FIG. 8b is a preferred embodiment of a receiving and preprocessing unit of a receiver which directly receives and constructs a balanced noise reference signal, in accordance with this invention.

FIG. 9a is an example of positions for directly receiving eight noise reference signals relative to the position for receiving information signal in a receiving and preprocessing unit of a receiver, in accordance with this invention.

FIG. 9b is a preferred embodiment of a receiving and preprocessing unit of a receiver which directly receives eight noise reference signals to construct a balanced noise reference signal in accordance with this invention.

FIG. 10 is a preferred embodiment of a receiver that uses two balanced noise reference signals and a three-input interference-based common mode noise eliminator to reduce in-band noise of an information signal, in accordance with this invention.

FIG. 11a is a preferred embodiment of a post frequency conversion common mode noise elimination unit which takes electromagnetic wave as input and uses a two-input interference-based common mode noise eliminator for noise elimination, in accordance with this invention.

FIG. 11b is a preferred embodiment of a post frequency conversion common mode noise elimination unit which takes electromagnetic wave as input and uses an electrical common mode noise eliminator for noise elimination, in accordance with this invention.

FIG. 11c is a preferred embodiment of a post frequency conversion common mode noise elimination unit which takes electrical signals as input and uses an electrical common mode noise eliminator for noise elimination, in accordance with this invention.

FIG. 12 is a preferred embodiment of a transmission preparation unit which prepares information input for transmitting it as differential signals, in accordance with this invention.

FIG. 13 is a preferred embodiment of a receiving and preprocessing unit of a receiver for differential signaling that uses two heterodyne or homodyne based receiving unit, in accordance with this invention.

FIG. 14a is a preferred embodiment of a receiving and preprocessing unit of a receiver for differential signaling, where a shared noise reference signal is obtained by splitting a received input signal into multiple signals, in accordance with this invention.

FIG. 14b is a preferred embodiment of a receiving and preprocessing unit of a receiver for differential signaling, which directly receives a shared noise reference signal, in accordance with this invention.

FIG. 14c is a preferred embodiment of a receiving and preprocessing unit of a receiver for differential signaling, which directly receives two unshared noise reference signals, in accordance with this invention.

FIG. 14d is a preferred embodiment of a receiving and preprocessing unit of a receiver for differential signaling, which directly receives one shared and two unshared noise reference signals to form two balanced noise reference signals, in accordance with this invention.

FIG. 15a is a preferred embodiment of a post frequency conversion common mode noise elimination unit for differential signaling, which constructs a shared noise reference signal and uses two two-input interference-based common mode noise eliminators and one electrical common mode noise eliminator for noise elimination, in accordance with this invention.

FIG. 15b is a preferred embodiment of a post frequency conversion common mode noise elimination unit for differential signaling, which constructs two unshared noise reference signals, and uses two two-input interference-based common mode noise eliminators and one electrical common mode noise eliminator for noise elimination, in accordance with this invention.

FIG. 15c is a preferred embodiment of a post frequency conversion common mode noise elimination unit for differential signaling, which uses one shared and two unshared noise reference signals to form two balanced noise reference signals, and uses two two-input interference-based common mode noise eliminators and one electrical common mode noise eliminator for noise elimination, in accordance with this invention.

FIG. 15d is a preferred embodiment of a post frequency conversion common mode noise elimination unit for differential signaling, which uses one shared and two unshared noise reference signals to form balanced noise reference signals, and uses two three-input interference-based common mode noise eliminators and one electrical common mode noise eliminators for noise elimination, in accordance with this invention.

FIG. 16a is a preferred embodiment of a post frequency conversion common mode noise elimination unit for differential signaling, which constructs a shared noise reference signal, and uses three electrical common mode noise eliminators for noise elimination, in accordance with this invention.

FIG. 16b is a preferred embodiment of a post frequency conversion common mode noise elimination unit for differential signaling, constructs two unshared noise reference signals, and uses three electrical common mode noise eliminators for noise elimination, in accordance with this invention.

FIG. 16c is a preferred embodiment of a post frequency conversion common mode noise elimination unit for differential signaling, which uses one shared and two unshared noise reference signals to form two balanced noise reference signals, and uses three electrical common mode noise eliminators for noise elimination, in accordance with this invention.

Throughout the drawings, the same reference numerals indicate similar or corresponding features or functions.

### DETAILED DESCRIPTION OF THE INVENTION

Details of this invention will be described in six sections. We will first present the noise-reduction method in Section 1. After explaining the organization of the embodiments in Section 2, we will present the overall system in Section 3 and describe the main embodiments in Section 4 and Section 5. Section 6 gives more examples for variations of the embodiments.

In the text below, the term “spectrum” means frequency spectrum and “linewidth” means spectral linewidth. The term “system requirements” refers to system cost requirements, reliability requirements, and system performance requirements. The terms “single-ended signal”, “differential signal”, “non-inverting”, and “inverting”, follow typical definitions used in electrical engineering. As defined in electrical engineering, a differential signal consists of a non-inverting signal and an inverting signal.

1. The Noise-reduction Method

The noise-reduction method of this invention uses out-of-band noise reference signals to cancel in-band noise of a desired information signal through common mode noise elimination. An out-of-band noise reference signal can itself carry desired information, such as in the case of differential signaling. Alternatively, it can solely serve the purpose of canceling in-band noise of a desired information signal. They are referred to simply as noise reference signals or reference signals in the rest of the text.

The method defines selection criteria and devises techniques for constructing reference signals for a desired information signal. The method takes advantage of the fact that unwanted background radiation has much broader spectrum than information signal carriers. The criteria are general guidelines since specific values are typically chosen after considering overall system requirements. For this reason, we use terms like “sufficiently small” to mean small enough to satisfy desired system requirements. Examples of how to apply the criteria in particular situations will be given when describing the embodiments. Below we will first present the principle steps of the method, and then describe the criteria for further increasing noise reduction.

When application of the method in noise reduction of one information-carrying signal is independent of its application to noise reduction of other information-carrying signals, the method consists of the following principle steps:

1) Partitioning the spectrum of electromagnetic waves of interest into multiple spectral partitions, a signal partition and at least one reference partition, such that:

a) the signal partition preferentially includes the energy spectrum of desired information signal, and

b) unwanted broad-spectrum background radiation preferably affects said spectral partitions similarly.

2) Transmitting a signal whose spectrum is substantially the signal partition.

3) Receiving input signals that contain the desired information signal along with unwanted background radiation.

4) Extracting from received input signals and constructing a desired carrier signal so that the spectrum of the carrier signal is substantially the signal partition,

5) Extracting from received input signals and constructing a reference signal so that the spectrum of the reference signal is substantially the union of the reference partitions, and

6) Differencing the carrier signal and the reference signal through destructive interference between the signals or through taking the difference between electrical signals converted from the signals to generate a noise-reduced output signal.

A reference signal can either be an unbalanced noise reference signal or a balanced noise reference signal. The spectrum of an unbalanced noise reference signal lies either above or below the spectrum of a desired information signal. Using balanced noise reference signal can improve the effectiveness of noise rejection. A balanced noise reference signal of a desired information signal contains an upper noise reference signal and a lower noise reference signal, where the spectrum of the upper noise reference signal has a higher frequency range than the spectrum of the information signal and the spectrum of the lower noise reference signal has a lower frequency range than the spectrum of the information signal.

When the method is applied to information transmitted as a differential signal pair comprising a first information signal and a second information signal, noise cancellation for each individual information signal can still be performed independently as described above. However, differential signaling allows the signals in a differential pair to be used as reference signals for each other. As a result, the method consists of the following principle aspects:

1) Partitioning the spectrum of electromagnetic waves of interest into a first signal partition, and a second signal partition such that the spectral partitions contain unwanted broad-spectrum background radiation approximately equally.

2) Converting information input into a first modulating signal and a second modulating signal so that said modulating signals belong to a differential signal pair.

3) Generating a first information signal and a second information signal, so that: the spectrum of said first information signal is substantially said first signal partition, the spectrum of said second information signal is substantially said second signal partition, said first information signal is modulated by said first modulating signal, and said second information signal is modulated by said second modulating signal.

4) Transmitting said first information signal and said second information signal towards a receiver, via a communication link.

5) Receiving input signals from the link so that the input signals contain the energy of the first information signal and the second information signal arrived at the receiver.

6) Extracting from received input signals and constructing a first carrier signal so that the spectrum of the first carrier signal is substantially the first signal partition,

7) Extracting from received input signals and constructing a second carrier signal so that the spectrum of the second carrier signal is substantially the second signal partition, and

8) Differencing the first carrier signal and the second carrier signal through destructive interference between the signals or through taking the difference between electrical signals converted from the signals to generate a noise-reduced output signal.

Differential signaling further allows the signal pair to share a noise reference signal. Using a shared reference signal allows wider separation between the spectra of the differential signals. In this case, the spectral partitions further include a shared partition so that the shared partition is intermediate between the first signal partition and the second signal partition. The shared partition is chosen so as to preferentially exclude both energy spectrum of the first information signal and energy spectrum of the second information signal. A shared reference signal is constructed from received input signals so that the spectrum of the shared reference signal is substantially the shared partition.

The shared reference signal is then split into a first shared reference signal and a second shared reference signal. The first shared reference signal is used to cancel in-band noise of the first carrier signal and the second shared reference signal is used to cancel in-band noise of the second carrier signal; both using differencing mechanisms. This stage of noise reduction generates a noise-reduced first carrier signal and a noise-reduced second carrier signal. If desired, a second stage differencing can be applied to the noise-reduced first carrier signal and a noise-reduced second carrier signal to further reduce noise in both signals.

Each signal of a differential pair can also be noise reduced using a balanced noise reference signal. A balanced reference signal for one carrier signal can either use the noise contained in the other signal as one component, or use part of a shared noise reference signal as one component. In both cases, the spectral partitions further include an upper partition and a lower partition; the spectrum of the upper partition is preferably higher than the higher frequency range of both the first signal partition and the second signal partition; the spectrum of the lower partition is preferably lower than the lower frequency range of both the first signal partition and the second signal partition. The upper partition and the lower partition are chosen so as to preferentially exclude both energy spectrum of the first information signal and energy spectrum of the second information signal.

Let's assume that the spectrum of the first signal partition higher than that of the second signal partition. An upper noise reference signal and a lower noise reference signal are constructed from received input signals so that the spectrum of the upper noise reference signal is substantially the upper partition and the spectrum of the lower noise reference signal is substantially the lower partition.

If no shared reference signals are used, the upper noise reference signal is used to cancel noise of the first carrier signal using a first common mode noise eliminator. Independently the lower noise reference signal is used to cancel noise of the second carrier signal using a second common mode noise eliminator. The output signals can then pass a third common mode noise eliminator to further reduce noise.

Should a shared noise reference signal be used, the spectral partitions further include the shared partition stated above and construct the shared reference signal from received input signals so that the spectrum of the shared reference signal is substantially the shared partition. The shared reference signal is then split into a first shared reference signal and a second shared reference signal. The first shared reference signal and the upper reference signal form a balanced signal and are used to cancel the noise in the first carrier signal. Meanwhile the second shared reference signal and the lower reference signal form another balanced signal and are used to cancel the noise in the second carrier signal. Again the noise of the output signals can be further reduced by passing the output signals through a third common mode noise eliminator.

For more effective noise cancellation, the spectral partitioning and signal construction described above preferably also partly or wholly satisfy the selection criteria defined below. The criteria will be described using a pair of signals. If more than one reference signal is used for an information signal, every reference signal should preferably satisfy the criteria with respect to the information signal.

Let signal1 and signal2 be two signals whose noise components effectively cancel each other through common mode noise elimination at a receiver. The spectrum of electromagnetic waves of interest is preferably partitioned into two partitions. Let f₁ and w₁ be the center frequency and linewidth of the first partition. Let f₂ and w₂ be the center frequency and linewidth of the second partition. Signal1 is constructed so that its spectrum is substantially the first partition and signal2 is constructed so that its spectrum is substantially the second partition. Let I₁ be the average power spectra density (PSD) of signal1, and I₂ be the average PSD of signal2. Let a₁ be the proportional constant of device1 that converts signal1 to electrical signals, and a₂ be the proportional constant of device2 that converts signal2 to electrical signals, where the proportional constant is device dependent and is substantially equal to the ratio of the strength of an electrical output signal of a signal detection and conversion device to the intensity of an input signal of the device. The selection criteria vary depending on the mechanism of common mode noise elimination and whether signal1 and signal2 belong to a differential pair; they are presented in three cases.

Case 1: an interference-based noise eliminator is used. Signal1 carries desired information that is transmitted via signal t₁ whose center frequency is fₜ₁ and linewidth is wₜ₁. Signal2 does not carry desired information. In this case, the selection criteria consist of:

a) f₁ is substantially equal to fₜ₁ and w₁ is substantially equal to pwₜ₁, where p is large enough so that the SNR of signal1 satisfies system performance requirements;

b) The absolute value of f₁−f₂ is sufficiently small so that at a receiver background radiation affects signal1 and signal2 approximately equally;

c) The difference in total intensity of signal1 and signal2, i.e. the absolute value of I₁w₁−I₂w₂, is approximately equal to the total intensity of the portion of signal t₁ that arrives at the interference location;

d) The path difference between signal1 and signal2 at the interference location is sufficiently smaller than the coherence length of signal1 and signal2, i.e. the path difference is smaller than C/w, where w=max(w₁, w₂) and C is the speed of light;

e) Polarization state of signal1 and signal2 is controlled so that noise cancellation satisfies system performance requirements.

f) Effective destructive interference between signal1 and signal2 at the interference location is maintained over a measurement interval, or the degree of destructive interference varies in a known fashion so that it can be compensated in a later process. This can be achieved through techniques such as frequency shifting and using media with different indices of refraction for propagating the signals.

Case 2: an electrical common mode noise eliminator is used. Signal1 carries desired information transmitted via signal t₁ whose center frequency is fₜ₁ and linewidth is wₜ₁. Signal2 does not carry desired information. In this case the selection criteria require:

a) f₁ is substantially equal to fₜ₁ and w₁ is substantially equal to pwₜ₁, where p is large enough so that the SNR of signal1 satisfies system performance requirements;

b) The absolute value of f₁−f₂ is sufficiently small so that background radiation affects signal1 and signal 2 approximately equally at a receiver;

c) The difference in the strength of the electrical signals converted from signal1 and signal2, i.e. the absolute value of a₁I₁w₁−a₂I₂w₂, is approximately equal to the strength of electrical signals converted from the portion of signal t₁ that reaches the common mode noise eliminator.

Case 3: an electrical common mode noise eliminator is used. Signal1 and signal2 belong to a differential signal pair and they are used to cancel each other's in-band noise. Signal1 carries a non-inverting information signal transmitted via signal t₁ whose center frequency is fₜ₁ and linewidth is wₜ₁. Signal2 carries an inverting information signal transmitted via signal t₂ whose center frequency is fₜ₂ and linewidth is Wₜ₂. In this case, the selection criteria require:

a) f₁ is substantially equal to fₜ₁ and w₁ is substantially equal to pwₜ₁, where p is large enough so that the SNR of signal1 satisfies system performance requirements;

b) f₂ is substantially equal to fₜ₂ and w₂ is substantially equal to qwₜ₂, where q is large enough so that the SNR of signal2 satisfies system performance requirements;

c) The absolute value of f₁−f₂ is sufficiently small so that background radiation affects signal1 and signal2 approximately equally at a receiver;

d) The strength of the electrical signal converted from signal1, i.e. a₁I₁w₁, is approximately equal to the strength of the electrical signal converted from signal2, i.e. a₂I₂w₂.

Since the method can be applied at various places in a receiver, the spectrum of electromagnetic waves of interest is relative to where it is applied. For example, when it is applied at initial receiving stage of a receiver to reduce noise in a desired signal, the spectrum of interest includes the spectrum of the desired signal that arrives at the receiver from a communication link and the spectra of the reference signals to be used. When the method is employed after a frequency conversion stage, the spectrum of interest includes the spectrum of the desired signal outputted by the conversion stage and the spectra of the reference signals to be used. Consequently, center frequency and linewidth of each and every signal involved are relative to where the method is applied.

For simplicity, in all the examples given in the embodiments of Section 4 and 5, it is assumed that a₁ is substantially equal to a₂, when the selection criteria are applied. Designers may choose to take the difference between a₁ and a₂ into account if desired.

When signal detection and conversion is involved in Case 2 and Case 3 above square-law conversion is used as an example to derive mathematical expressions. However, square-law conversion is not required for applying the method. If devices other than square-law conversion devices are used, application of the method should preferably follow the text and view the mathematical expressions as only examples.

For easy reference, when signal1 and signal2 satisfy the selection criteria, we say that signal1 and signal2 are noise reference signals, or simply reference signals, to each other.

2. General Consideration and Organization of the Embodiments

The method of this invention can be applied in various system configurations. As a result, the number of possible embodiments is quite large; only example embodiments from a few main categories are described. These categories are: 1) the method is applied to one information signal independent of its application to other information signals, this application is referred to as group1 embodiments; 2) the method is applied to the two information signals of a differential signal pair, this application is referred to as group2 embodiments; 3) the method is applied at the initial stages of a receiver; 4) the method is applied at least once and after at least one frequency conversion stage in a receiver.

Presentation of the embodiments is further complicated by the fact that the logical functions of the method can be implemented either as self-contained devices or distributed in system components in various ways. For easier understanding, the functionalities are logically put in self-contained units in the embodiments. Those skilled in the art can choose to distribute and/or regroup the functionalities as desired.

To avoid over repetitiveness in description, the logical functions are partitioned and grouped into units chosen so that the embodiments all share some components while differ in others. This allows us to describe the entire system once and then only need to describe new and/or different aspects of a new embodiment. An additional intention of the functional grouping is to enable pick-and-choose of components from a variety of possible unit embodiments to form a system. In other words, the unit boundaries do not impose limitations to distributing and regrouping the functionalities as will be shown later in some examples.

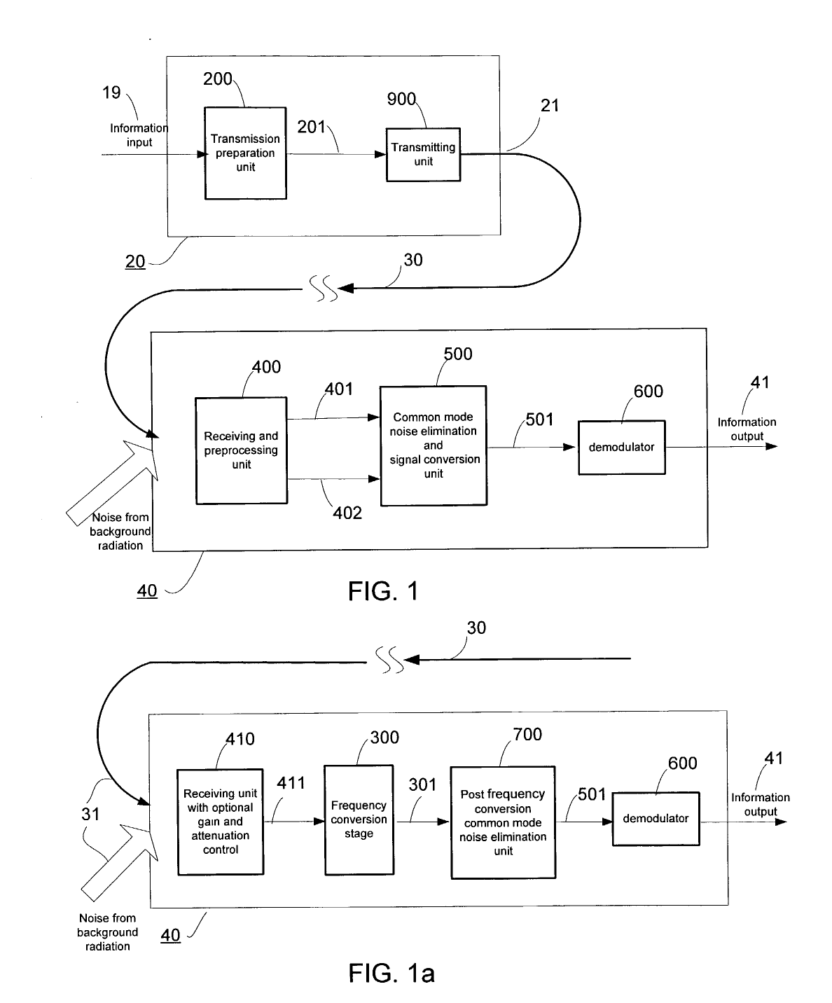

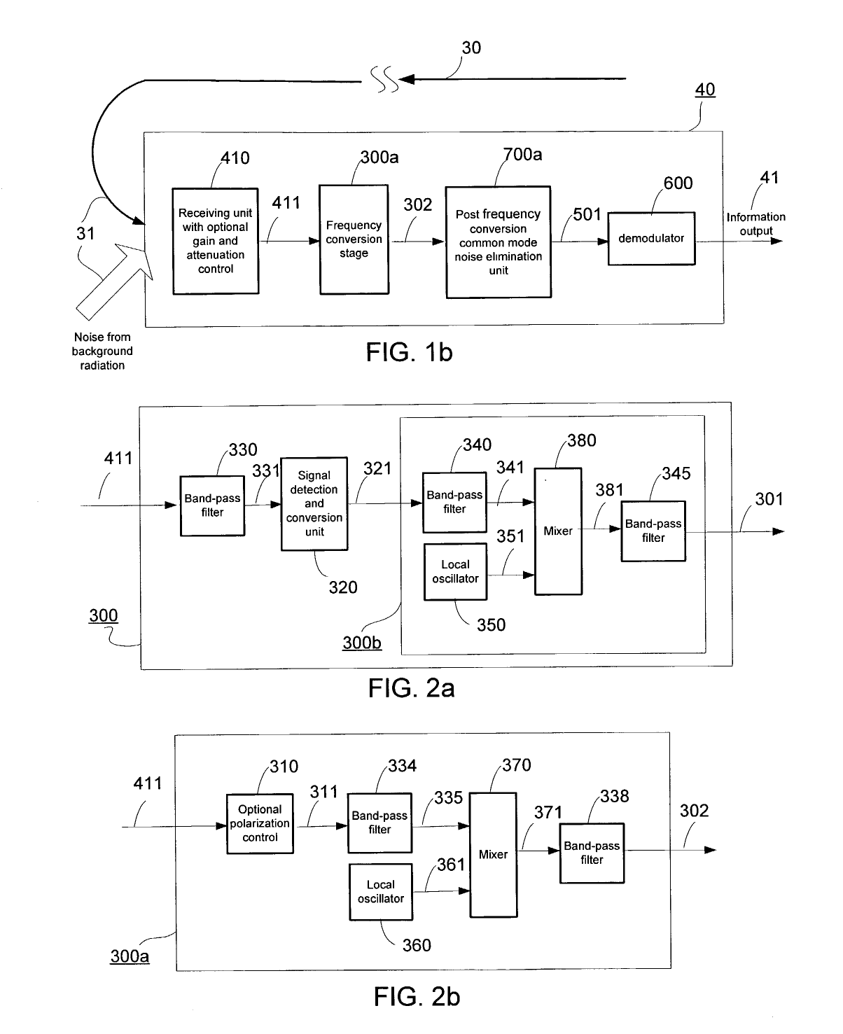

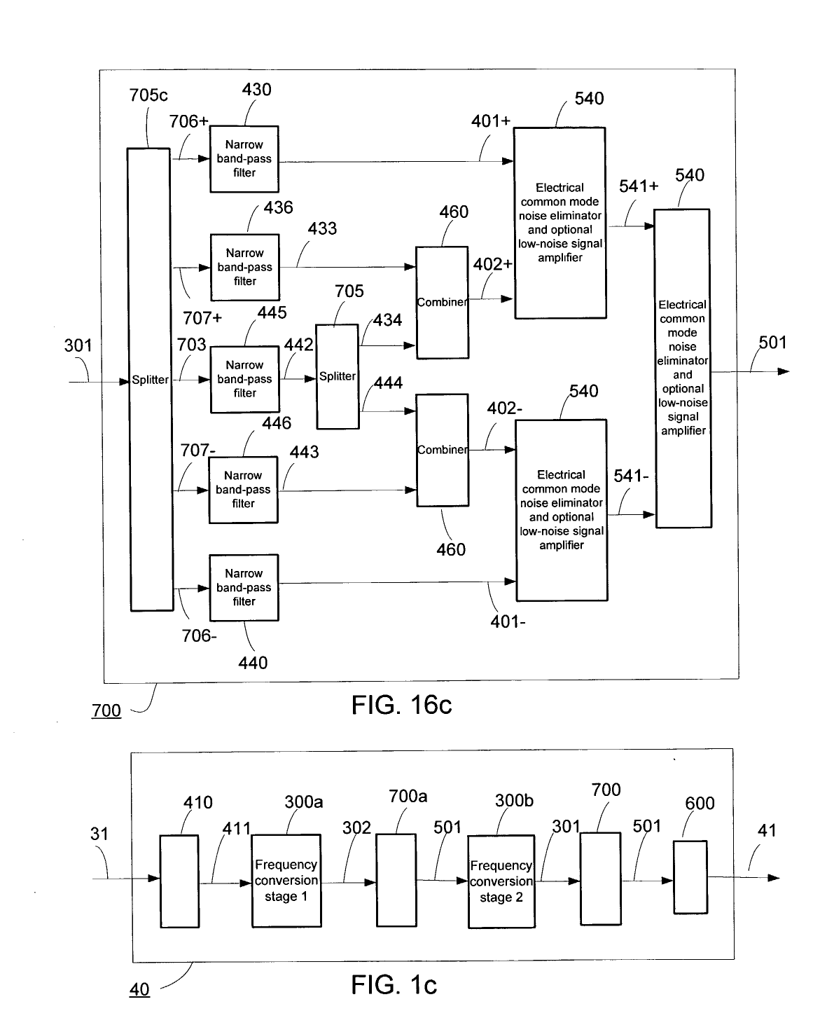

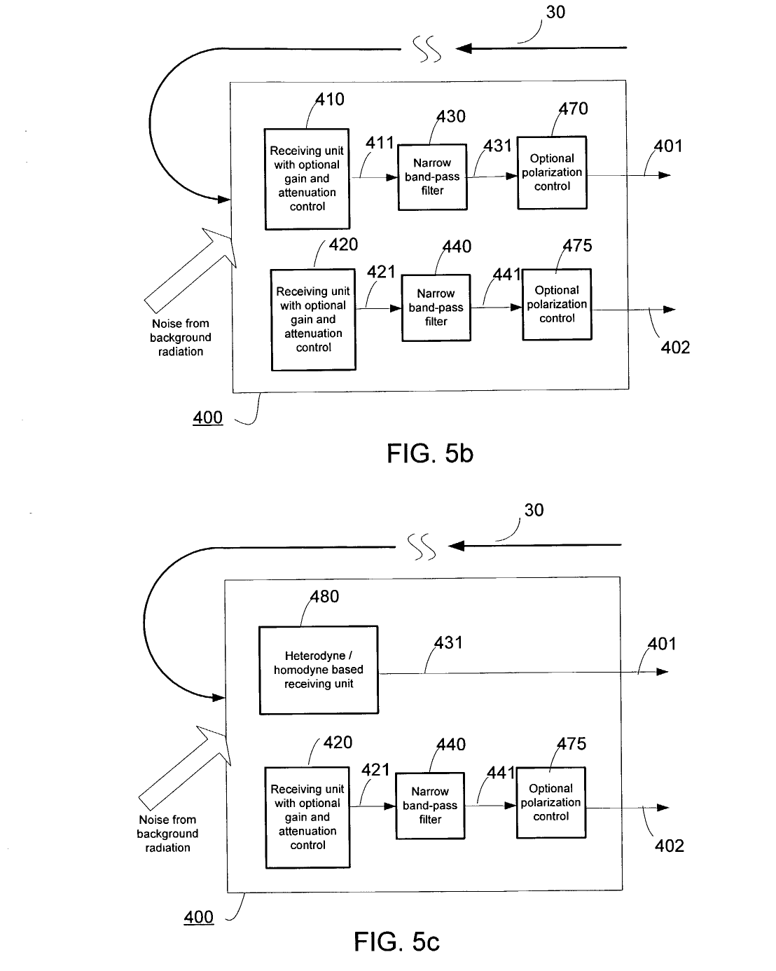

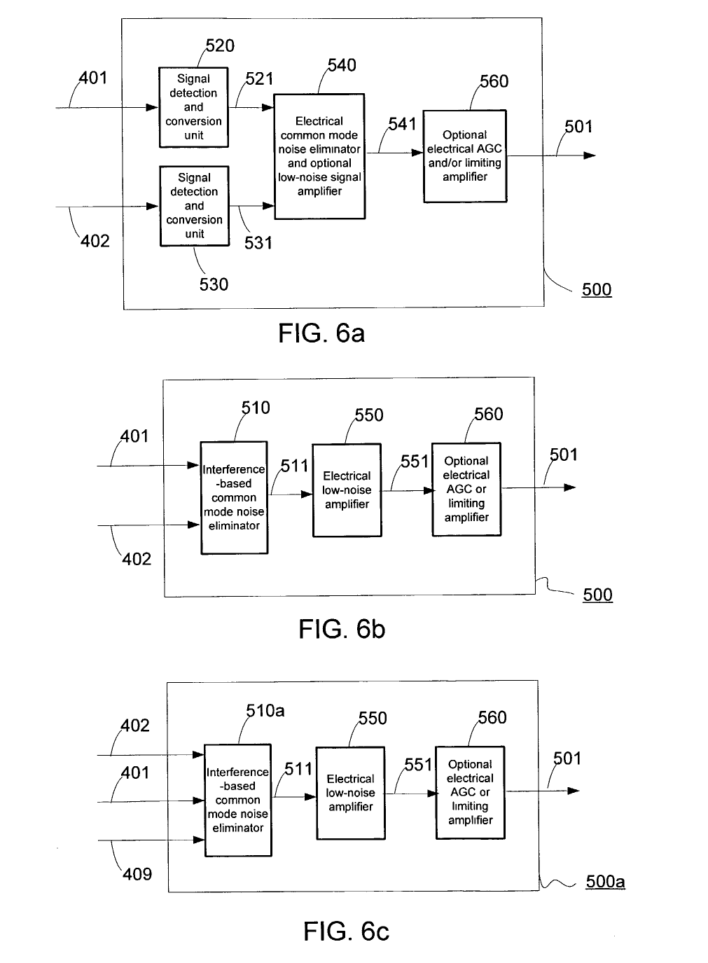

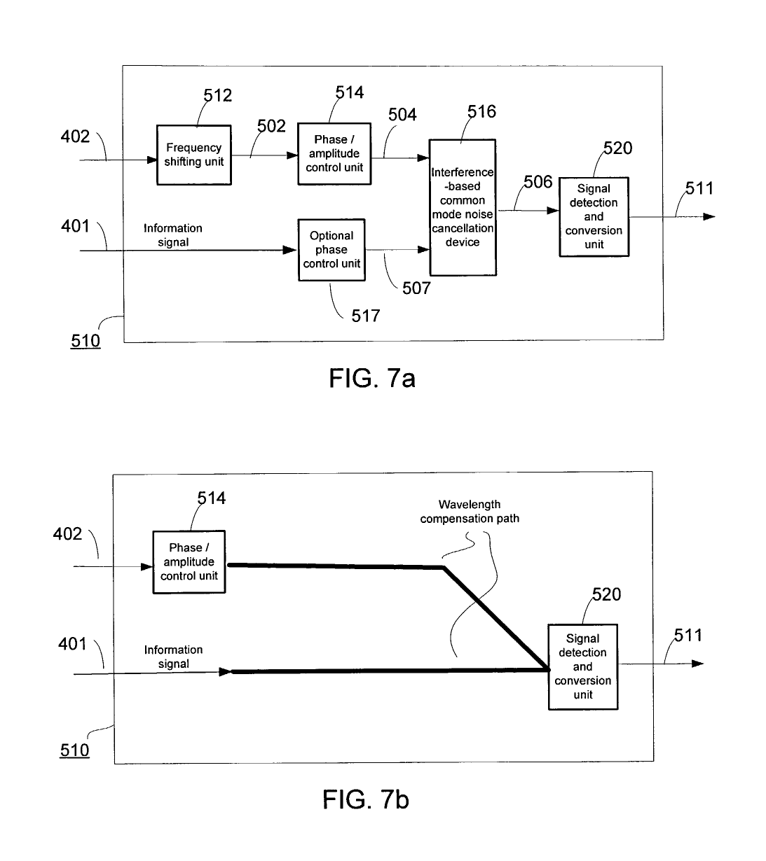

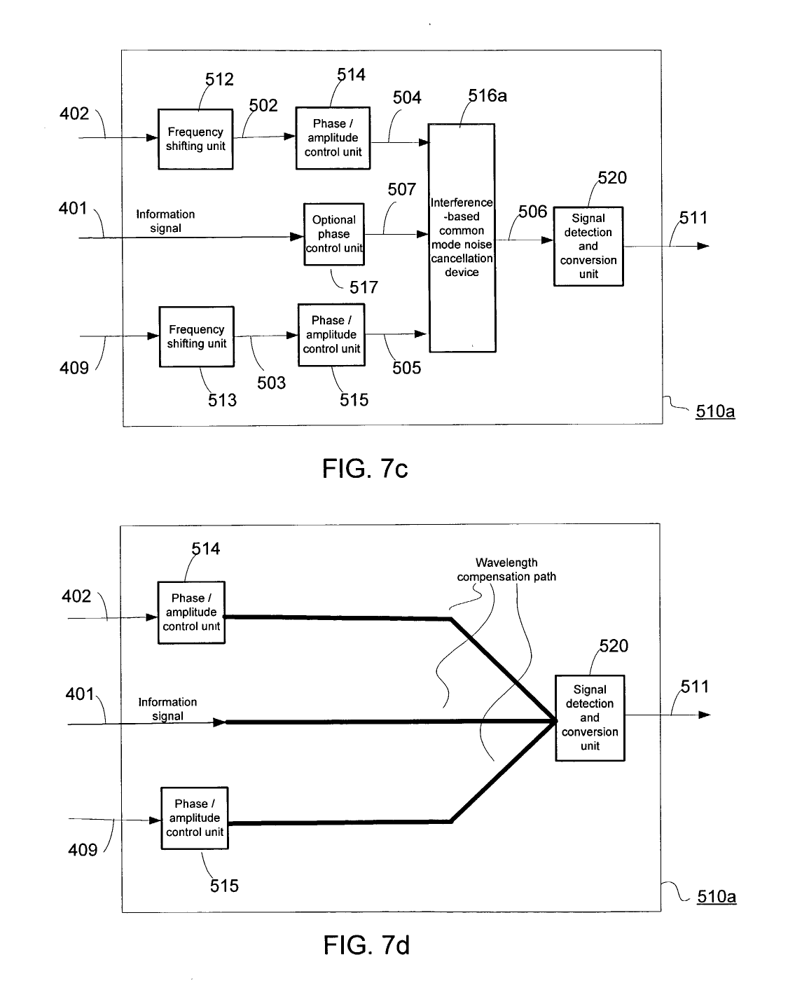

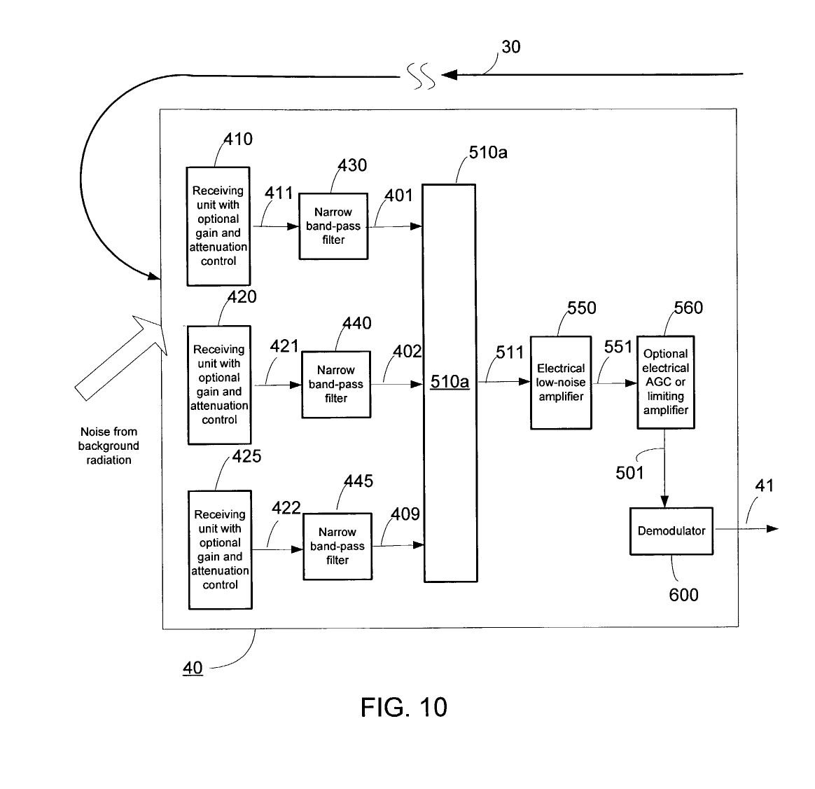

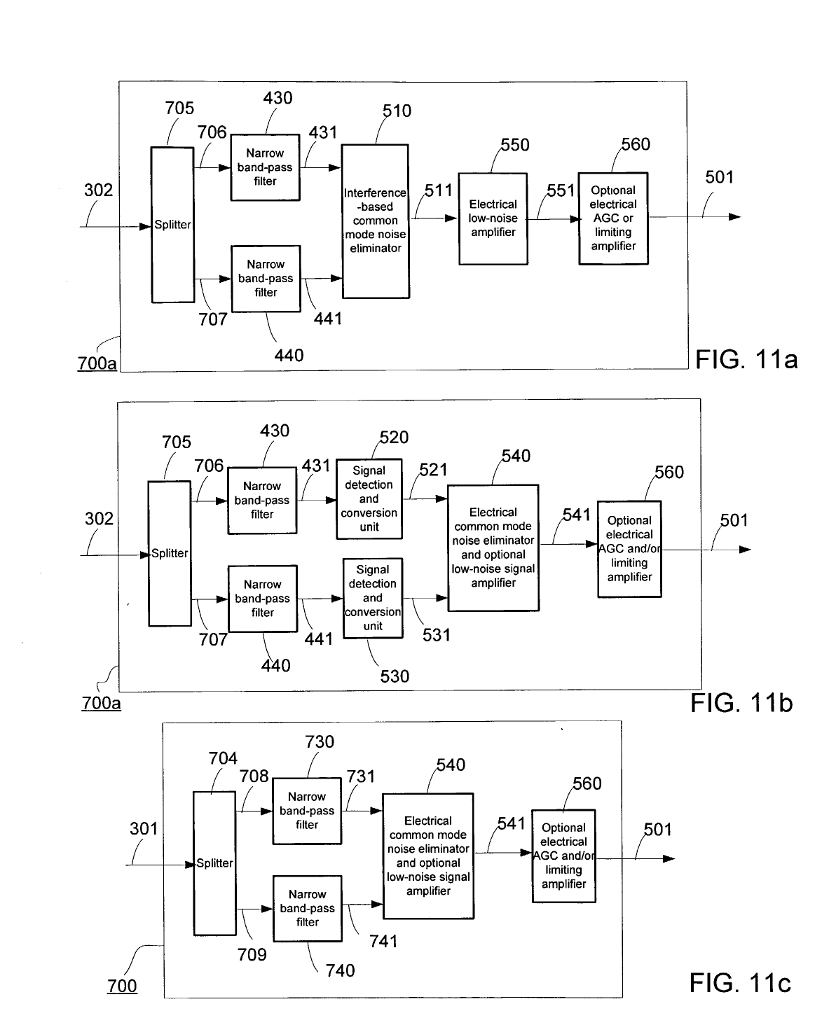

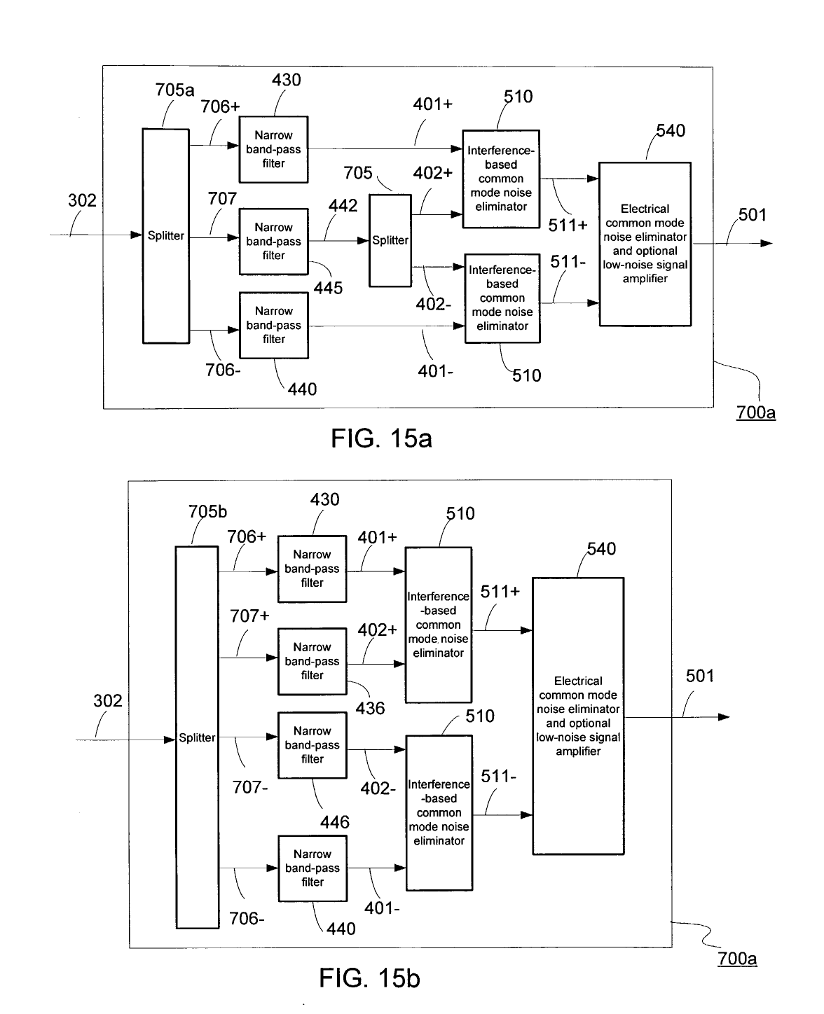

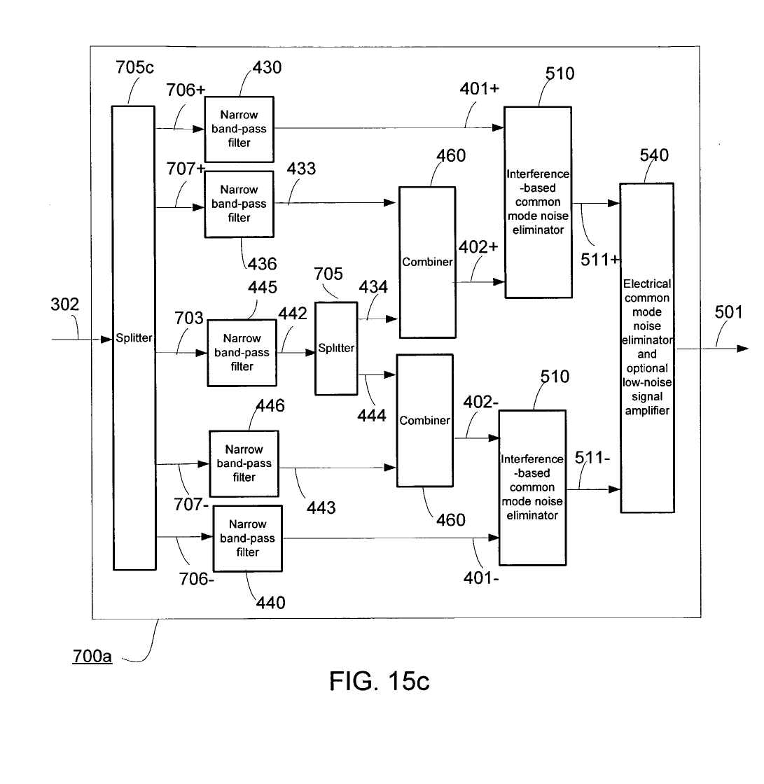

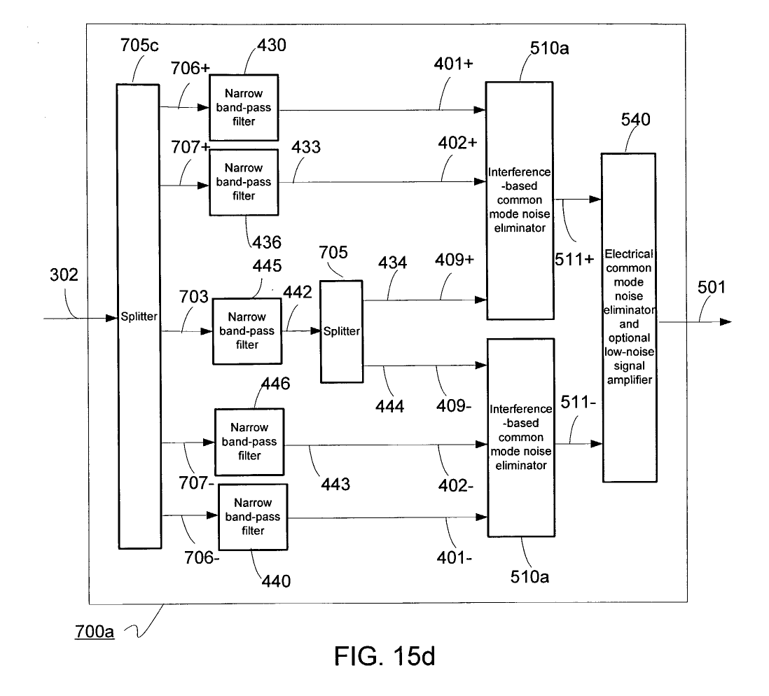

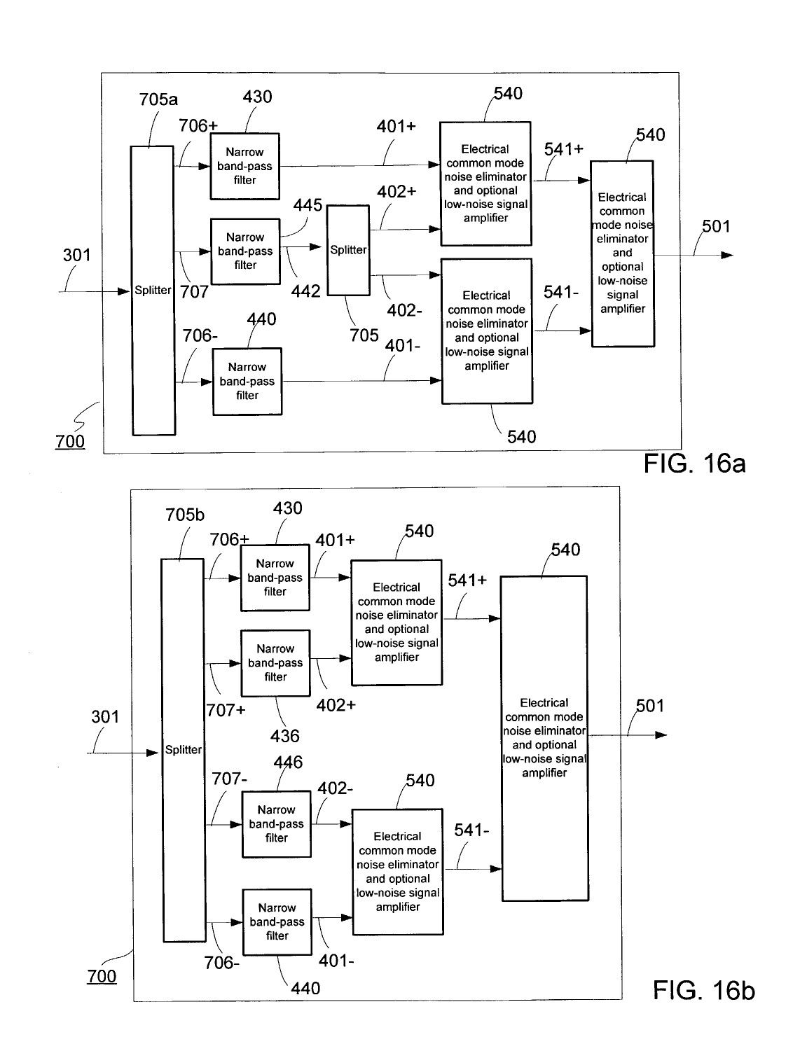

As a result of the partitioning, the following unit embodiments are interchangeable. Receiver 40 in FIGS. 1, 1a, 1b, 1c, and 10 are interchangeable. Group1 unit 400 in FIGS. 5a, 5b, 5c, 8a, 8b, and 9b are interchangeable. Group2 unit 400 in FIGS. 5a, 5b, 13, 14a, 14b, 14c, and 14d are interchangeable. Unit 500 in FIGS. 6a and 6c are interchangeable. Unit 510 in FIGS. 7a and 7b are interchangeable. Unit 510a in FIGS. 7c and 7d are interchangeable. Group1 unit 700 in FIGS. 11a and 11b are interchangeable. Group2 unit 700 in FIGS. 15a, 15b, 15c, and 15d are interchangeable, and group2 unit 700 in FIGS. 16a, 16b, and 16c are interchangeable.

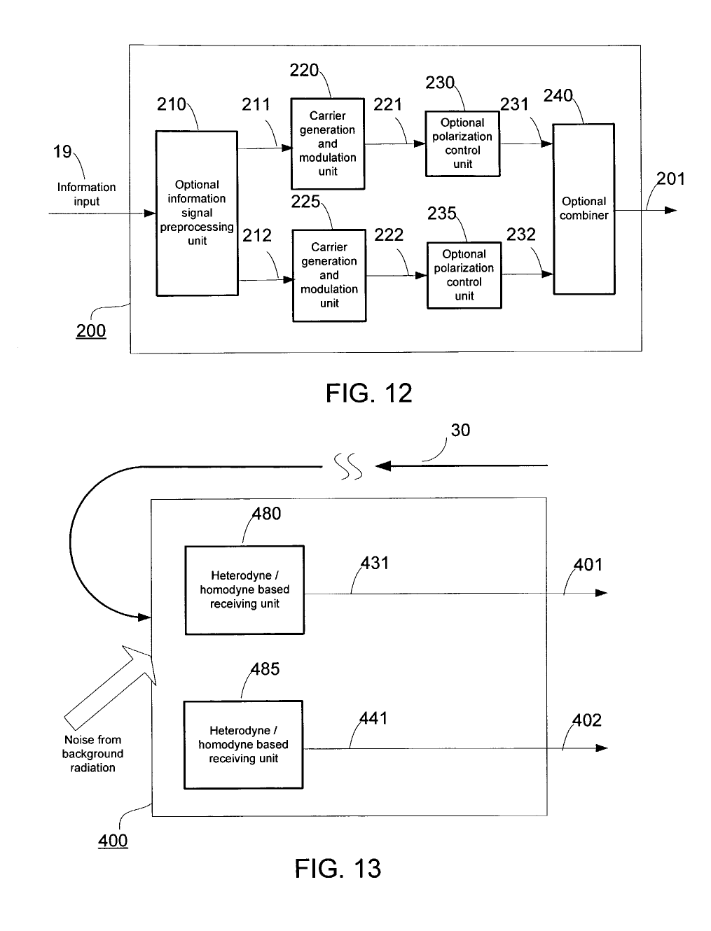

After presenting the overall system in Section 3, we will describe the details of a complete system using group1 embodiments in Section 4. In Section 5, we will then present group2 embodiments. In each section, we will describe the embodiments of the method applied at the initial stages of a receiver, followed by describing the embodiments of the method applied after at least one frequency conversion stage in a receiver. The figures are sequenced in the order of presentation. They relate to the groups as follows. FIGS. 1, 1a, 1b, 1c, 2a, 2b, 3a, 3b, 5a, 5b, 6a, 6b, 6c, 7a, 7b, 7c, 7d, 11a, 11b, and 11c are common to both group1 and group2. FIGS. 4, 5c, 8a, 8b, 9a, 9b, and 10 belong to group1, and FIGS. 12, 13, 14a, 14b, 14c, 14d, 15a, 15b, 15c, 15d, 16a, 16b, and 16c belong to group2.

For clarity, common engineering practices used in communication systems, such as signal amplification and impedance matching, and techniques specific to particular applications, such as polarization processing and dispersion control, are not elaborated if they are not essential to describing the principles of this invention. However many of these commonly used practices and/or prior-art noise-reduction techniques can be employed in a same system together with the techniques of this invention.

Unless otherwise stated, in all embodiments when an optional unit is omitted in an implementation, the input of the omitted unit becomes the output without any modifications.

The term “signal path” is used for the convenience of describing embodiments. It is defined as a sequence of functional units through which a signal travels starting from input and ending at a place where common mode noise elimination occurs.

3. Overall System

FIG. 1 shows an embodiment of a communication system of this invention. The system comprises a transmitter 20, a receiver 40, and a communication link 30 between the transmitter and the receiver. Transmitter 20 comprises a transmission preparation unit 200 and a transmitting unit 900. It accepts information input signals 19, prepares them for transmission, and transmits signal 21 carrying information to receiver 40, via link 30.

The double-s-shaped symbol indicates the continuation of link 30 over a distance. As a first example, link 30 covers the distance between two buildings. As a second example, link 30 covers the distance between a ground station and a communication satellite orbiting the earth. As a third example, link 30 covers the distance between two communication satellites.

Electromagnetic waves arriving at receiver 40 along link 30 contain information carried by signal 21 and unwanted background radiation. Receiver 40 receives the arriving waves, rejects noise, extracts desired signals, and outputs information signals 41 in an electrical form. Four example embodiments are shown for receiver 40. FIG. 1 shows the first embodiment; it applies the method of this invention at the initial stage of a receiver. FIGS. 1a and 1b show embodiments where the method is applied after one frequency conversion stage in a receiver. FIG. 1c (on the drawing page 20/20) shows a receiver where the method is applied twice: after a first frequency conversion stage and then after a second frequency conversion stage.

Receiver 40 in FIG. 1 comprises a receiving and preprocessing unit 400, a common mode noise elimination and signal conversion 500, and a demodulator 600. Unit 400 receives input from link 30 and outputs an information signal 401 and a noise reference signal 401. Signals 401 and 402 pass through unit 500 where the noise in signal 401 is reduced. Signal 501, the output of unit 500, then passes through demodulator 600 which recovers and outputs information output 41.

Receiver 40 in FIG. 1a contains a receiving unit with optional gain and attenuation control 410. A receiving unit with optional gain and attenuation control receives input signals arriving at receiver 40. The input signals contain information signals of interest and unwanted noise from background radiation. When a receiver operates in an environment where intensity of input signals varies strongly, gain and attenuation control is preferably used to maintain the intensity of input signals entering the receiver at a desired and substantially uniform level.

Receiver 40 in FIG. 1a further contains a frequency conversion stage 300, post frequency conversion common mode noise elimination unit 700, and demodulator 600. Stage 300 takes signal 411, the output of unit 410, as input and outputs electrical signal 301 so that the spectrum of signal 301 is substantially in a desired frequency range. Unit 700 takes signal 301 as input and output a noise-reduced electrical output signal 501.

Receiver 40 in FIG. 1b comprises a receiving unit with optional gain and attenuation unit 410, frequency conversion stage 300a, post frequency conversion common mode noise elimination unit 700a, and demodulator 600. Stage 300a takes signal 411, the output of unit 410, as input and outputs electromagnetic wave signal 302 so that the spectrum of signal 302 is substantially in a desired frequency range. Unit 700a takes signal 302 as input and outputs a noise-reduced electrical output signal 501.

Embodiment of receiver 40 in FIG. 1c is intended to be an example where unit 700 and/or unit 700a can be applied at multiple places in a receiver. As shown in the figure, a unit 700a takes output 302 from a frequency conversion stage 300a and output noise-reduced electrical signal 501. The spectrum of signal 501 is then further shifted by passing through frequency conversion stage 300b. Output signal 301 of stage 300b is then further noise reduced by passing through unit 700 before being demodulated by unit 600.

FIGS. 1, 1a, 1b, and 1c also show that signal 501 can be immediately demodulated by demodulator 600 or undergo further processing, such as amplification, signal shaping, and further noise reduction before being demodulated. Since frequency conversion stage and demodulator are applicable for both group1 and group2 embodiments, they are presented in this section.

FIG. 2a shows example embodiments of frequency conversion stage 300 and frequency conversion stage 300b. Stage 300 takes signal 411, the output of receiving unit with optional gain and attenuation control 410 in FIG. 1a, as input and outputs frequency-shifted electrical signal 301. Stage 300b takes an electrical signal as input and outputs frequency-shifted electrical signal 301. FIG. 2b gives example embodiment of frequency conversion stage 300a. Stage 300a takes signal 411 as input, and outputs frequency-shifted electrical magnetic wave signal 302.

A frequency conversion stage shifts the spectrum of its input signal to a desired frequency range. Techniques for frequency shifting are commonly used in receivers; this invention does not impose any limitations on the selection of frequency shifting techniques to be used for supporting the noise-reduction method. Furthermore, this invention does not limit the number of frequency conversion stages to be used in receiver 40, and the method can be employed after any frequency conversion stages and at one or more places as shown in the example of FIG. 1c.

Frequency conversion stage 300 in FIG. 2a contains band-pass filter 330, signal detection and conversion unit 320, band-pass filter 340, local oscillator 350, mixer 380, and band-pass filter 345; it outputs a frequency-shifted electrical signal 301. Filter 330 performs initial selection of a spectrum so that its output signal 331 has a higher SNR for desired information signals compared to input signal 411. Signal 331 is then converted into an electrical signal by passing through signal detection and conversion unit 320. Signal 321, the electrical output signal of unit 320, is further shaped by band-pass filter 340 so that the spectrum of output signal 341 matches input requirements of mixer 380. Local oscillator 350 is tuned so that its output signal 351 effectively selects desired information signal after being mixed with signal 341. Signal 341 and signal 351 then pass through mixer 380 to generate output signal 381. Band-pass filter 345 takes signal 381 as input and outputs signal 301 so that signal 301 contains desired information and its spectrum has been shifted to a desired range in comparison with the spectrum of signal 321.

Frequency conversion stage 300b in FIG. 2a contains band-pass filter 340, local oscillator 350, mixer 380, and band-pass filter 345. It takes an electrical signal as input and outputs a frequency-shifted electrical signal 301. In FIG. 2a it takes signal 321 as input. However it can also take other electrical signal as input such as signal 501, output of unit 700 or 700a, as shown in FIG. 1c. Its principle of operation is the same as stated in the previous paragraph.

Frequency conversion stage 300a in FIG. 2b shifts the spectrum of input signal 411 using similar principles, except its output signal 302 comprises electromagnetic waves. Optional polarization control unit 310 changes the polarization state of input signal 411 if desired. Band-pass filter 334 further shapes signal 311, the output of unit 310, so that the spectrum of its output signal 335 matches input requirements of mixer 370. Local oscillator 360 is tuned so that its output signal 361 effectively selects desired information signal after being mixed with signal 335. Signal 335 and signal 361 then pass through mixer 370 to generate output signal 371. Band-pass filter 338 takes signal 371 as input and outputs signal 302, so that signal 302 contains desired information and its spectrum has been shifted to a desired range in comparison with the spectrum of signal 311.

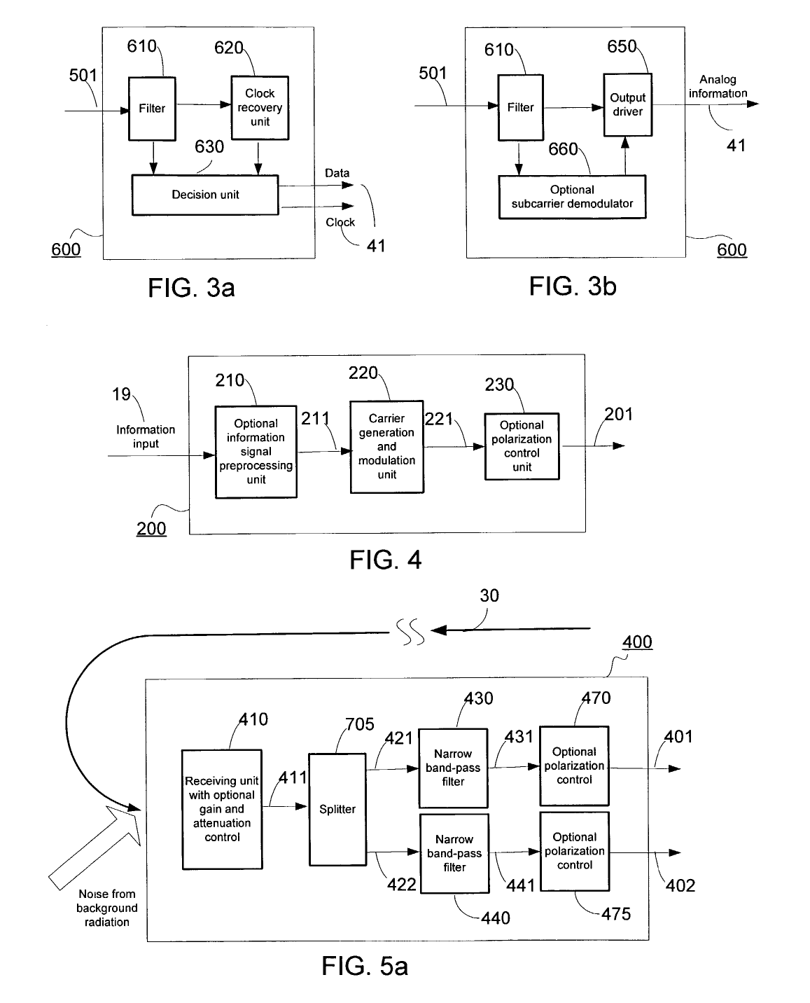

Demodulator 600 takes electrical signals as input and extracts desired information from the input. As shown in FIG. 3a, an example digital demodulator comprises a filter 610, a clock recovery unit 620 and a decision unit 630. Filter 610 reshapes output signal 501 so that the signals are better matched with unit 620 and unit 630. Unit 620 extracts the clock information, and unit 630 makes the decision regarding whether the signal is digital data 1 or digital data 0. Digital demodulator 600 then outputs the digital data and the clock information.

FIG. 3b shows an example of an analog demodulator. As shown in FIG. 3b, an example analog demodulator comprises filter 610, output driver 650, and optional sub-carrier demodulator 660. Filter 610 extracts desired information signal and shapes the signal to be better matched with the rest of the demodulator circuit. Unit 660 extracts analog information signals when subcarriers are used, and output driver 650 reshapes the signals to match output requirements. Analog demodulator 600 outputs extracted analog signals.

Circuitry of both digital and analog demodulator is well known in electrical engineering. Techniques for further error reduction may be employed in demodulator circuitry.

All embodiments that will be presented in the next two sections call for estimating the intensity of in-band noise of a desired information signal. This is equivalent to estimating the intensity of the portion of the transmitted information signal that arrives at an observation location in receiver 40. One example of an observation location is at the entrance of receiver 40. Another example of the observation location is at the entrance of a post frequency conversion common mode noise elimination unit of receiver 40. The estimate can be derived from system design parameters or obtained through sample acquisition at the observation location.

4. Group1 Embodiments—Independent Noise-reduction of a Single Signal

In this section, we will describe the details of a complete system using simplest group1 embodiments of unit 400 followed by more complicated group1 embodiments of unit 400. We will then give an example of receiver 40 that uses a three-input common mode noise eliminator 510a for noise cancellation. Units of this group labeled using same numerals are interchangeable and can replace the unit with same label in FIGS. 1, 1a, 1b, and 1c. The embodiment described in this section are applicable to any information signals, including differential signals, when noise-reduction of one information signal is independent of noise-reduction of any other information signals.

When information input enters transmitter 20, it is first processed by transmission preparation unit 200. FIG. 4 shows a group1 embodiment of unit 200. They include optional information signal preprocessing unit 210, carrier generation and modulation unit 220, and optional polarization control unit 230. In cases where information input does not directly match system transmission requirements, unit 210 is used to transform the input. The transformation includes encoding, impedance matching, and signal buffering. Through unit 210, input information signals are transformed to signal 211 according to selected coding algorithms, modulation schemes, and signaling schemes. In digital systems, unit 210 may also perform clock insertion.

Unit 220 generates a carrier signal 221 whose center frequency fₛ and linewidth wₛ are preferably selected to optimize overall system performance. Signal 221 is modulated by signal 211 so that the information is carried by signal 221. Controlling polarization may be important in some systems, e.g. in systems using coherent receivers, such as heterodyne and homodyne receivers. Unit 230 provides capability for polarization selection, transformation, and control, and transforms signal 221 to signal 201 that will satisfy polarization requirements.

The output signal 201 from unit 200 is then passed to transmitting unit 900. Unit 900 may apply further processing to signal 201, such as laser mode control in some cases of optical communication, if needed. It then transmits signal 21 towards receiver 40 via link 30.

Information signal 21 together with noise from background radiation arrives at receiver 40 along link 30 and is received by receiving and preprocessing unit 400 of the receiver. All embodiments of unit 400 use receiving unit with optional gain and attenuation control. When operating in an environment where intensity of input signals varies strongly, gain and attenuation control is preferably used to maintain the intensity entering the receiver at a desired and substantially uniform level.

Narrow band-pass filters are used in all embodiments of unit 400 to shape signals for noise cancellation. Examples of these filters include conventional band-pass filters, interferometers, and heterodyne-based band-pass filters. When used for this purpose, the center frequencies and bandwidths of the filters should preferably be selected so that their output signals satisfy the selection criteria. Specific values of center frequencies and bandwidths of the filters involved are typically the result of design tradeoffs between various system requirements. For example, the center frequencies are close enough and bandwidths are narrow enough to satisfy the selection criteria yet the strength of desired information signal is sufficiently high and inter-symbol interference is acceptable.

To avoid over repetitiveness, the selection of the pass-band width of a narrow band-pass filter will be described as “sufficiently larger than wₛ, the linewidth of signal L” when appropriate, where L is the labeling numeral of an information signal and wₛ is the signal linewidth. For example, a filter pass-band width can be kwₛ, where k is approximately between 1 and 3.

FIG. 5a shows an embodiment of receiving and preprocessing unit 400 where information signal path and noise reference signal path share receiving unit with optional gain and attenuation control 410 and splitter 705. The information signal path further contains narrow band-pass filter 430 and optional polarization control unit 470. The reference signal path further contains narrow band-pass filter 440 and optional polarization control unit 475.

As shown in the figure, unit 410 receives input signals arriving at receiver 40 and uses its gain and attenuation control to maximize SNR of its output signal 411. Splitter 705 then splits signal 411 into signal 421 and signal 422, with approximately equal intensity, and preferably signal 421 retains most of the energy of signal 21 arrived at unit 410. Signal 421 passes through narrow band-pass filter 430 whose center frequency is set to be substantially equal to fₛ, the center frequency of information signal 21, and whose pass-band width is set to be sufficiently larger than wₛ, the linewidth of signal 21. This setup ensures that the output signal 431 of filter 430 contains information carried by signal21.

At the same time, signal 422 passes through narrow band-pass filter 440 whose center frequency and pass-band width depends on the setup of filter 430. For demonstration purposes, let's assume that the pass-band width of filter 430 is 2wₛ. The center frequency of filter 440 is then set to be substantially equal to either fₛ+2wₛ or fₛ−2wₛ, and its pass-band width is set to be substantially equal to 2wₛ. This setup ensures that output signal 441 of filter 440 is a noise reference signal of signal 431. The intensity of signals 422 is preferably adjusted so that the intensity of signal 441 is approximately equal to the intensity of in-band noise of signals 431.

The above setup is merely an example; bandwidth and center frequency of filter 440 can be tuned to maximize the reduction of in-band noise of signal 431. For example, noise reduction can be increased if the center frequency of filter 440 is substantially fₛ+1.5wₛ or fₛ−1.5wₛ and its bandwidth is substantially wₛ. The principle of this optimization applies to all setup examples in this document and will not be repeated.

Optional polarization control units 470 and 475 can be used to control polarization states of signals 431 and 441 to satisfy system requirements if needed. Unit 400 outputs two signals 401 and 402, where signal 401 contains information and in-band noise, and signal 402 is a noise reference signal of signal 401.

FIG. 5b shows an embodiment of receiving and preprocessing unit 400 where information signal path and noise reference signal path have separate receiving units with optional gain and attenuation control, unit 410 for information signal path and unit 420 for reference signal path. The information signal path further contains narrow band-pass filter 430 and optional polarization control unit 470. The reference signal path further contains narrow band-pass filter 440 and optional polarization control unit 475.

Unit 420 is placed physically close enough to unit 410 so that background radiation affects both units approximately equally. While unit 410 is preferably tuned to maximize SNR in its output signal 411, unit 420 is preferably tuned so that the intensity of signal 421 is approximately equal to the intensity of the in-band noise of signal 411.

Similar to the embodiment in FIG. 5a, output signal 411 passes through narrow band-pass filter 430 followed by optional polarization control unit 470, while simultaneously output signal 421 passes through narrow band-pass filter 440 followed by optional polarization control unit 475. Setup of filters 430 and 440 and the usage of units 470 and 475 are the same as described in the embodiment in FIG. 5a. Consequently, output signal 401 contains information and in-band noise, and output signal 402 is a noise reference signal of signal 401.

FIG. 5c shows an embodiment of receiving and preprocessing unit 400 where a heterodyne or homodyne receiving unit is used in the information signal path to receive input signals arriving at receiver 40 and to generate information-carrying signal 431 so that the center frequency and linewidth of signal 431 is the same as in the embodiment of FIG. 5b. Signal 431 directly becomes output signal 401. The settings for devices along the path of noise reference signal remain the same as in the embodiment of FIG. 5b. The phase difference between signals 431 and 441 should preferably be adjusted if required and polarization of transmitted signal 21 should preferably be controlled through unit 230 of FIG. 4 if required.

Output signals 401 and 402 of unit 400 then simultaneously pass through common mode noise elimination and signal conversion unit 500, where noise reference signal 402 effectively cancels the in-band noise in information signal 401. Common mode noise cancellation can be performed either electrically or through destructive interference.

FIG. 6a shows an embodiment of common mode noise elimination and signal conversion unit 500 with an electrical common mode noise eliminator. Entering unit 500, signal 401 is converted to electrical signal 521 using signal detection and conversion unit 520 so that output 521 preserves transmitted information and matches the signal requirements of the non-inverting input of electrical common mode noise eliminator and optional low-noise signal amplifier 540. At the same time, signal 402 is converted into electrical signal 531, using signal detection and conversion unit 530, so that output 531 matches the signal requirements of the inverting input of unit 540. Unit 540 eliminates noise common in signals 521 and 531 and output electrical output signal 541. Electrical differential amplifiers and instrumentation amplifiers are examples of unit 540. Signal 541 can either directly go into a demodulator if further processing is not needed. It can also first go through optional electrical AGC and/or limiting amplifier 560 to ensure that its output signal 501 properly matches the requirements of demodulator 600, where AGC means automatic gain control.

FIG. 6b and FIG. 6c show embodiments of common mode noise elimination and signal conversion unit that use interference-based common mode noise eliminators. Unit 500 in FIG. 6b uses a two-input interference-based common mode noise eliminator 510, and unit 500a in FIG. 6c uses a three-input interference-based common mode noise eliminator 510a. Both unit 510 and unit 510a output electrical signal 511. Signal 511 may be directly demodulated, or it may go through further processing, such as going through a series of electrical signal filtering and amplification provided by electrical low-noise amplifier 550 and optional electrical AGC or limiting amplifier 560, and output a noise-reduced electrical output signal 501.

Amplifier 550 plays a key role in determining receiver sensitivity and noise performance. While also contributes to system noise performance, the main role of amplifier 560 is to ensure that its output signal 501 properly matches the requirements of demodulator 600. Design of amplifiers 550 and 560 are well understood and will not be elaborated further. Units 550, 560, and demodulator 600 can also be integrated into one circuit if desired.

FIG. 7a and FIG. 7b show embodiments of a two-input interference-based common mode noise eliminator 510; unit 510 takes information signal 401 and noise reference signal 402 as input. The embodiment in FIG. 7a uses a frequency shifting unit 512 to shift the frequency of noise reference signal 402 so that signal 402 maintain proper alignment with information signal 401 over a measurement interval and therefore the effectiveness of noise cancellation is improved, or the alignment varies in a known fashion so that it can be compensated in a later process. Output signal 502 of unit 512 then passes through phase and amplitude control unit 514 so that the phase and amplitude of its output signal 504 are adjusted for effective noise cancellation. When needed, the phase of information signal 401 can also be adjusted using optional phase control unit 517.

Signal 507, the output of unit 517, and in-band noise of signal 504 destructively interfere when they pass through interference-based noise cancellation device 516, and emerge as a noise-reduced information signal 506. Device 516 provides mechanisms to cause its two input signal to meet and interfere at a desired location in space. Examples of the mechanisms include redirection, focusing, and combination of electromagnetic waves.

FIG. 7b shows an alternative embodiment of unit 510; it uses wavelength compensation path to maintain proper alignment of its input signals. In this implementation, a phase and amplitude control unit 514 is first used to adjust the phase and amplitude of noise reference signal 402 for more effective noise cancellation. Information signal 401 and the output of unit 514 then propagate in media with different indices of refraction. The path of signal 401 and the path of signal 402 meet at an interference location where signal 402 destructively interferes with in-band noise of information signal 401. The values of the indices and the lengths of the paths are selected so that effective noise cancellation at the interference location is preferably maintained over a measurement interval, or the degree of destructive interference varies preferably in a known fashion such that it can be compensated in a later process.

Signal detection and conversion unit 520 in both embodiments of FIGS. 7a and 7b are for converting the input signal of unit 520 to noise-reduced electrical output signal 511. In the embodiment of FIG. 7a, unit 520 takes signal 506 as its input. In the embodiment of FIG. 7b, unit 520 is placed substantially at the interference location. PIN diode-based and APD-based detection devices are examples of unit 520.

FIGS. 7c and 7d show examples of embodiments of three-input interference-based common mode noise eliminator 510a; unit 510a takes information signal 401, noise reference signal 402, and noise reference signal 409 as input. The path for signal 401 and the path for signal 402 in FIG. 7c remain the same as in FIG. 7a, and the path for signal 401 and the path for signal 402 in FIG. 7d remain the same as in FIG. 7b.

The embodiment in FIG. 7c has an additional path for noise reference signal 409. Along this path,frequency shifting unit 513 and phase and amplitude control unit 515 adjust the frequency, phase, and amplitude of signal 409 for better noise cancellation. The output signal 505 of the additional path, together with signal 504, destructively interferes with in-band noise of signal 507, when these three signals pass through interference-based common mode noise cancellation device 510a. Device 516a provides mechanisms to cause its three input signals to meet and interfere at a desired location in space. Examples of the mechanisms include redirection, focusing, and combination of electromagnetic waves. A Signal detection and conversion unit 520 takes signal 506 as input and outputs noise-reduced electrical signal 511.

The embodiment in FIG. 7d has an additional path for noise reference signal 409. Along this path, phase and amplitude of reference signal 409 are first adjusted by phase and amplitude control unit 515. The output signal of unit 515 then propagates through a medium whose index of refraction is preferably different than the refractive indices of both the path of signal 401 and the path of signal 402. The three signal paths meet at an interference location where signal 409, together with signal 402, destructively interferes with in-band noise of signal 401. The indices of refraction and the lengths of the three propagation paths are selected so that effective noise cancellation at the interference location is preferably maintained over a measurement interval, or the degree of destructive interference varies preferably in a known fashion so that it can be compensated in a later process. Signal detection and conversion unit 520 is located substantially at the interference location and converts the input to noise-reduced electrical signal 511.

Same principle can be applied to an interference-based common mode noise eliminator that takes more than three input signals for noise reduction; it will not be repeated here.

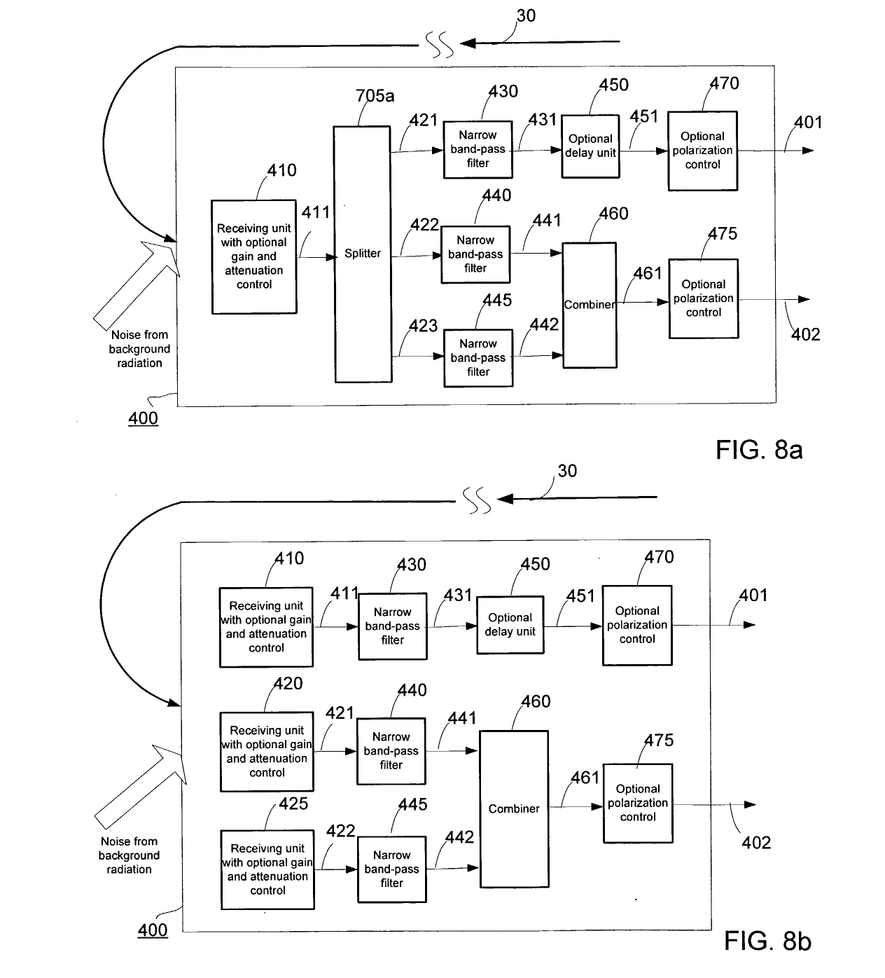

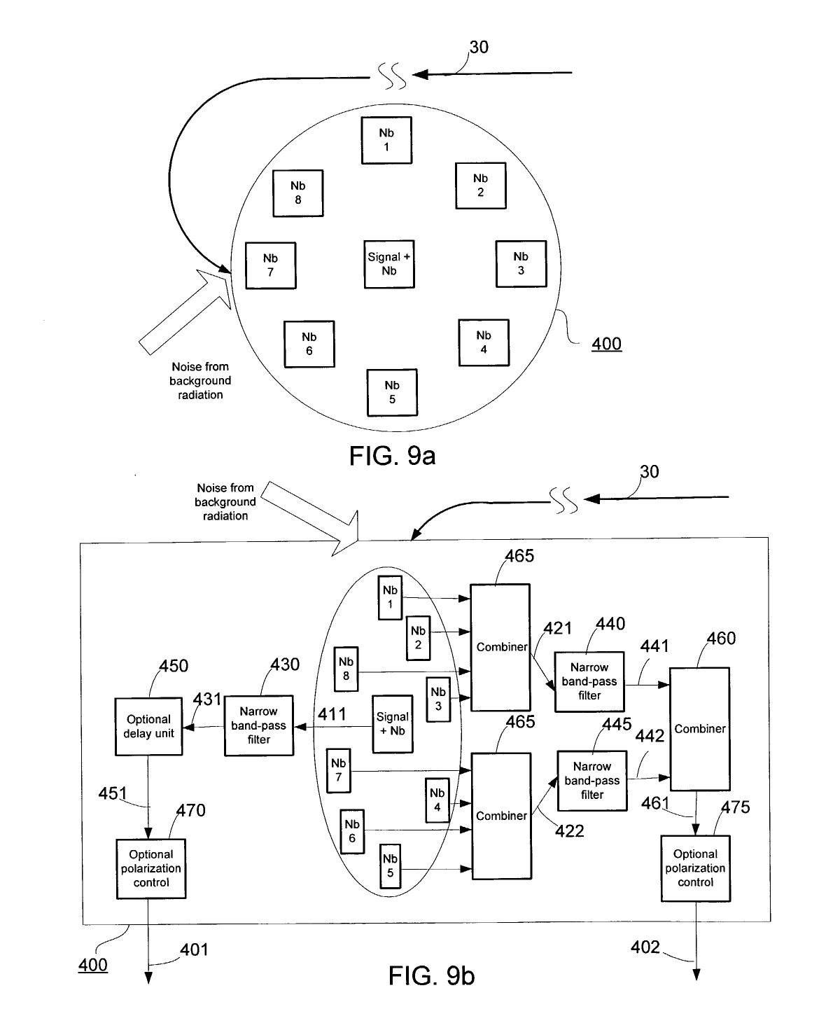

So far we have described the embodiments in which an unbalanced noise reference signal is constructed by receiving and preprocessing unit 400. The spectrum of an unbalanced noise reference signal of an information signal lies close to and either above or below the spectrum of the information signal. Using balanced noise reference signal can improve the effectiveness of noise reduction. A balanced noise reference signal of an information signal comprises an upper noise reference signal and a lower noise reference signal, where the spectrum of the upper noise reference signal is preferably close to and higher than the spectrum of the information signal, and the spectrum of the lower noise reference signal is preferably close to and lower than the spectrum of the information signal. Embodiments of unit 400 that construct balanced noise reference signals are shown in FIGS. 8a, 8b, and 9b.

Embodiment of receiving and preprocessing unit 400 shown in FIG. 8a contains three signal paths, an information signal path, a first noise reference signal path, and a second noise reference signal path. All signal paths share receiving unit with optional gain and attenuation control 410 and splitter 705a. The information signal path further contains narrow band-pass filter 430, optional delay unit 450, and optional polarization control unit 470. The first reference signal path further contains narrow band-pass filter 440, combiner 460 and optional polarization control unit 475. The second reference signal path further contains narrow band-pass filter 445, combiner 460 and optional polarization control unit 475.

As shown in the figure, unit 410 receives input signals arriving at receiver 40 and adjusts its gain/attenuation to maximize SNR in its output signal 411. Splitter 705a then splits signal 411 into signal 421, signal 422, and signal 423. It is preferable to have signal 421 to contain most power of the information signal and have total combined intensity of signals 441 and 442 approximately equal to the total intensity of in-band noise of signal 431. Alternatively, the intensity of signals 421, 422, and 423 can be approximately 50%, 25%, and 25% respectively.

Signal 421 passes through narrow band-pass filter 430 whose center frequency is set to be substantially equal to fₛ, the center frequency of information signal 21, and whose pass-band width is set to be sufficiently larger than wₛ, the linewidth of signal 21. This setup ensures that signal 431 contains desired information signals.

Similar as before, let's assume the pass-band width of filter 430 is 2wₛ. Signal 422 passes through narrow band-pass filter 440 whose center frequency substantially equals to fₛ+2wₛ, and whose pass-band width substantially equals to 2wₛ. Setup of filter 440 ensures that output signal 441 is an upper noise reference signal of signal 431. At the same time, signal 423 passes through narrow band-pass filter 445 whose center frequency substantially equals to fₛ−2wₛ, and whose pass-band width substantially equals to 2wₛ. Setup of filter 445 ensures that output signal 442 is a lower noise reference signal of signal 431. Noise reference signals 441 and 442 are then combined by combiner 460 into a balanced noise reference signal 461.

Optional delay unit 450 is used to control phase difference between signals 431 and 461 if needed. Optional polarization control units 470 and 475 are used to control polarization states of signals 451 and 461 if needed. Again, unit 400 outputs signal 401 containing information and in-band noise, and signal 402, a noise reference signal of signal 401.

Embodiment of receiving and preprocessing unit 400 shown in FIG. 8b also contains three signal paths, an information signal path, a first noise reference signal path, and a second noise reference signal path. Unlike the case in FIG. 8a, these paths do not share any receiving unit with optional gain and attenuation control. The information signal path contains receiving unit 410, narrow band-pass filter 430, optional delay unit 450, and optional polarization control unit 470. The first reference signal path contains receiving unit 420, narrow band-pass filter 440, combiner 460, and optional polarization control unit 475. The second reference signal path contains receiving 425, narrow band-pass filter 445, combiner 460, and optional polarization control unit 475.

In this embodiment, information signal 411 is received by receiving unit 410, noise reference signal 421 is received by receiving unit 420, and noise reference signal 422 is received by receiving unit 425. Units 420 and 425 are preferably physically located close to unit 410 so that background radiation affects all three units approximately equally. Unit 410 is preferably tuned to maximize SNR in its output signal 411. Unit 420 is preferably tuned so that the intensity of output signal 421 is approximately half of the intensity of the in-band noise in signal 411. Similarly, unit 425 is preferably tuned so that the intensity of output signal 422 is also approximately half of the intensity of the in-band noise of signal 411.

Similar to the embodiment in FIG. 8a, output signal 411 passes through narrow band-pass filter 430, while simultaneously signal 421 passes through narrow band-pass filter 440 and signal 422 passes through narrow band-pass filter 445. Output of filters 440 and 445, signals 441 and 442, are then combined to form balanced reference signal 461. Setup of filters 430, 440 and 445, the use of unit 450, unit 470, and unit 475 is the same as described in the embodiment of FIG. 8a. Consequently, unit 400 outputs signal 401 containing information and in-band noise, and signal 402, a noise reference signal of signal 401.

Similar as shown in FIG. 5c, an alternative implementation of this embodiment replaces unit 410 and 430 of FIG. 8b with a single heterodyne or homodyne receiving unit so that the center frequency and linewidth of output signal 431 are the same as in the embodiment of FIG. 8b. The settings for the noise reference signals and other devices remain the same as in the embodiment of FIG. 8b. The phase difference between signals 451 and 461 should preferably be adjusted if required and polarization of transmitted signal 21 should preferably be controlled through unit 230 of FIG. 4 if required.

Output signals 401 and 402 of the above embodiments simultaneously pass through common mode noise elimination and signal conversion unit 500, where signal 402 effectively cancels in-band noise of signal 401. Either embodiments of unit 500 shown in FIGS. 6a and 6b can be used for this purpose.

More than two noise reference signals can be acquired if desired. FIGS. 9a and 9b show an embodiment of unit 400 where reference signals are acquired at eight locations. While FIG. 9a shows positions of noise acquisition relative to the position of information signal reception, FIG. 9b shows the corresponding embodiment of unit 400. In the figures, Nb stands for background noise. Signal+Nb is a receiving unit with optional gain and attenuation control that receives information signals; it is preferably tuned and physically placed to maximize SNR in its output signal 411. Nb 1 though 8 are eight receiving units with optional gain and attenuation control that receive noise reference signals; they are preferably physically placed so that background radiation affects all nine units approximately equally. It is preferable for the combined output intensity of all noise acquisition units to be substantially equal to the intensity of in-band noise of signal 411.

This embodiment has three signal paths. An information signal path contains receiving unit with optional gain and attenuation control Signal+Nb, narrow band-pass filter 430, optional delay unit 450, and optional polarization control unit 470. A first reference signal path contains four receiving units with optional gain and attenuation control, narrow band-pass filter 440, a first combiner 465, combiner 460, and optional polarization control unit 475. A second reference signal path contains the other four receiving units with optional gain and attenuation control, narrow band-pass filter 445, a second combiner 465, combiner 460, and optional polarization control unit 475.

As shown in FIG. 9b, information signal 411 goes through narrow band-pass filter 430, whose center frequency is substantially fₛ and whose bandwidth is substantially 2wₛ, following previous examples. It is preferable to have approximately half of the acquired noise signals combined into a first noise reference signal 421, and the other half combined into a second noise reference signal 422. The intensity of signals 421 and 422 are preferably adjusted so that the combined noise reference signal 461 is approximately equal to the intensity of in-band noise of signal 451. Signals 441 and 442 are then combined into a single reference signal 461 via combiner 460.

Similar to the embodiment in FIG. 8a, signal 421 goes through narrow band-pass filter 440, and signal 422 goes through narrow band-pass filter 445. Setup of filters 430, 440 and 445 is the same as the setup in the embodiment of FIG. 8a. The use of unit 450, unit 470, and unit 475 is the same as described in the embodiment of FIG. 8a. Unit 400 outputs signals 401 containing information and in-band noise, and signal 402, a noise reference signal of signal 401. Also same as before, signals 401 and 402 then pass through a unit 500 for noise rejection.

Similar as shown in FIG. 5c, an alternative implementation of this embodiment, not shown in the figures, replaces unit Signal+Nb and filter 430 of FIG. 9b with a heterodyne or homodyne receiving unit so that the center frequency and linewidth of output signal 431 are the same as in the embodiment of FIG. 9b. The settings for the noise reference signals and other devices remain the same as in the embodiment of FIG. 9b. The phase difference between signals 451 and 461 should preferably be adjusted if required, and polarization of transmitted signal 21 should preferably be controlled through unit 230 of FIG. 4 if required.

FIG. 10 shows a receiver embodiment that uses a three-input interference-based common mode noise eliminator 510a to reduce noise from an information signal. In this embodiment, information signal 411 and two noise reference signals 421 and 422 are received respectively using three receiving units with optional gain and attenuation control 410, 420 and 425. Same as in FIG. 8b, signal 411 goes through narrow band-pass filter 430, signal 421 goes through narrow band-pass filter 440, and signal 422 goes through narrow band-pass filter 445. Setup of these filters is the same as the embodiment of FIG. 8b. The output of filter 430 is connected to the information signal input 401 of unit 510a, and the output of filters 440 and 445 are connected to the noise reference signal input 402 and 409 of unit 510a. The noise-reduced electrical signal 511, output of unit 510a, can either be directly demodulated or go through more signal filtering and amplification processes, such as those provided by devices 550 and 560.

Alternatively, receiving units 410, 420, and 425 in embodiment of FIG. 10 can be replace by a receiving unit 410 connected to splitter 705a that outputs signal 411, signal 421 and signal 422 as in FIG. 8a.

Embodiments presented so far directly receive input signals arriving at receiver 40 from link 30. FIGS. 11a, 11b, and 11c show embodiments of post frequency conversion common mode noise elimination unit 700 and 700a whose input is substantially the output of a frequency conversion stage. The output of unit 700 or 700a, signal 501, can be directly sent to demodulator 600, as shown in FIGS. 1a and 1b or can go through more processing as shown in FIG. 1c.

Each and every embodiment in FIGS. 11a, 11b, and 11c contains an information signal path and a noise reference signal path; both paths share a splitter. Each and every information signal path of the embodiments in FIGS. 1a and 1b further contains narrow band-pass filter 430, and each and every reference signal path further contains narrow band-pass filter 440. The information signal path in FIG. 11b further contains signal detection and conversion unit 520, and the reference signal path further contains signal detection and conversion unit 530. Information path of embodiment in FIG. 11c further contains narrow band-pass filter 730, and its reference signal path further contains narrow band-pass filter 740.

Input of embodiments in FIG. 11a and FIG. 11b, signal 302, is substantially the output of a frequency conversion stage 300a shown in FIG. 2b. Consequently, the values of center frequency fₛ and linewidth wₛ of desired information signal are now determined by the connected stage. In both embodiments, splitter 705 splits signal 302 into signal 706 and signal 707. Signal 706 then passes through filter 430 and signal 707 passes through filter 440. Following the example of embodiment in FIG. 5a, center frequency of filter 430 is substantially fₛ and its pass-band width is substantially 2wₛ. Center frequency of filter 440 is substantially equal to either fₛ+2wₛ or fₛ−2wₛ, and its pass-band width is substantially 2wₛ. This setup ensures that output signal 431 of filter 430 carries information, and output 441 of filter 440 is a noise reference signal of signal 431.

In the embodiment shown in FIG. 11a, signal 431 and signal 441 then pass through interference-based common mode noise eliminator 510. Unit 510 outputs noise-reduced electrical signal 511 that can either directly go to a demodulator or go through more signal shaping and magnification provided by units 550 and 560 to generate output signal 501.

In the embodiment in FIG. 11b, signal 431 is converted to electrical signal 521 by passing through signal detection and conversion unit 520, and signal 441 is converted to an electrical signal 531 by passing through signal detection and conversion unit 530. Signals 521 and 531 then pass through electrical common mode noise eliminator and optional low-noise signal amplifier 540. Unit 541 outputs noise-reduced electrical signal 541 that can either directly go to a demodulator or go through more signal shaping and magnification provided by unit 560.

Input of the embodiment in FIG. 11c, electrical signal 301, is substantially the output of either a frequency conversion stage 300 or a frequency conversion stage 300b shown in FIG. 2a. Consequently, the values of center frequency fₛ and linewidth wₛ of desired information signal are now determined by the connected stage. Splitter 704 splits input 301 into signal 708 and signal 709. Signal 708 then goes through filter 730 and signal 709 then goes through filter 740. Center frequency of filter 730 is substantially fₛ and its pass-band width is substantially 2wₛ. The center frequency of filter 740 is substantially equal to either fₛ+2wₛ or fₛ−2wₛ, and its pass-band width is substantially 2wₛ. Output signal 731 of filter 730 carries information, and output 741 of filter 740 is a noise reference signal of signal 731. Signal 731 and signal 741 then go through electrical common mode noise eliminator and optional low-noise signal amplifier 540. Output signal 541 of unit 540 can either be directly demodulated or go through more processing provided by e.g. amplifier 560 to generate output signal 501.

5. Group2 Embodiments—Noise Reduction Using Differential Signals

Similar as group1 embodiments, units labeled with same numerals are interchangeable within group2 and can replace the unit with the same label in FIGS. 1, 1a, 1b, and 1c.

FIG. 12 shows an embodiment of transmission preparation unit 200 of transmitter 20 that uses differential signaling. Unit 200 for differential signaling contains optional information signal preprocessing unit 210, carrier generation and modulation units 220 and 225, optional polarization control units 230 and 235, and optional combiner 240. In addition to functions described in the embodiment in FIG. 4, unit 210 also converts information input 19 to differential signal pair comprising a non-inverting signal 211 and an inverting signal 212, if input 19 contains singled-ended signals.

Unit 220 generates carrier signal 221 whose center frequency fₙ and linewidth wₙ are selected to optimize overall system performance. Unit 225 generates carrier signal 222 whose center frequency fᵢ and linewidth wᵢ are also selected to optimize overall system performance. Signal 221 is modulated by non-inverting signal 211, signal 222 is modulated by inverting signal 212, and signals 221 and 222 are therefore a differential signal pair.

As mentioned before, noise from broadband background radiation contained in non-inverting or inverting signal can be reduced independent of each other using techniques described in Section 4. Differential signaling further enables in-band noise in each signal of a differential pair to cancel each other through common mode noise elimination. As will be discussed later, should a differential signal pair be used for common mode noise elimination, fₙ, wₙ and fₜ, w₁ should preferably satisfy the selection criteria; should receiver 40 acquire a shared noise reference signal, fₙ, wₙ and fᵢ, wᵢ should then preferably satisfy the selection criteria that accommodates the shared noise reference signal.

Similar to previously described embodiments, optional polarization control units 230 and 235 can be used to control the polarization states of signals 221 and 222 if required. The output of unit 200 for differential signaling depends on whether unit 240 is used. When unit 240 is used, unit 200 outputs a single combined signal 201 that contains both signal 231 and signal 232. When unit 240 is not used, unit 200 outputs two separate signals, comprising non-inverting carrier signal 231 carrying non-inverting signal 211 and inverting carrier signal 232 carrying inverting signal 212.

FIGS. 5a and 5b show the embodiments of receiving and preprocessing unit 400 where two signals in a differential pair are constructed so that in-band noise of the signals cancels each other. The embodiment in FIG. 5a contains two information signal paths. Both paths share receiving unit with optional gain and attenuation control 410 and splitter 705. A non-inverting signal path further contains narrow band-pass filter 430 and optional polarization control unit 470. An inverting signal path further contains narrow band-pass filter 440 and optional polarization control unit 475.

Unit 410 receives desired differential signals along with noise from background radiation. By adjusting the gain and attenuation control, it maximizes SNR of its output signal 411. Splitter 705 then splits signal 411 into signal 421 and signal 422, with approximately equal intensity.

Signal 421 goes through filter 430, whose center frequency is set to be substantially equal to fₙ, the center frequency of signal 231, and whose pass-band width is larger than wₙ, the linewidth of signal 231. This setup ensures that the output signal 431 contains the energy spectrum of non-inverting signal 231. Signal 422 goes through filter 440, whose center frequency is substantially equal to fₜ, the center frequency of signal 232, and whose pass-band width is larger than wₜ, the linewidth of signal 232. This setup ensures that its output signal 441 contains the energy spectrum of inverting signal 232. Let's consider an example in which wₙ=wᵢ, fₙ>fᵢ, and the bandwidths of filters 430 and 440 are both substantially 2wₙ. The selection criteria then require fₙ−fᵢ>=2wₙ.

The embodiment in FIG. 5b has two information signal paths. A non-inverting signal path comprises receiving unit with optional gain and attenuation control 410, narrow band-pass filter 430, and optional polarization control units 470. An inverting signal path comprises receiving unit with optional gain and attenuation control 420, narrow band-pass filter 440, and optional polarization control units 475. Unit 410 and unit 420 are preferably physically placed and tuned to maximize the SNR of their respective output signals 411 and 421. They are also preferably placed physically close enough to each other so that background radiation affects both units approximately equally.

Similar to the embodiment of FIG. 5a, signal 411 and signal 421 go through filters 430 and 440 respectively. Setting of the filters is the same as the group2 embodiment of FIG. 5a. Consequently, filter output signals 431 and 441 contain desired differential signals and their in-band noise will cancel each other through common mode noise elimination.

In both embodiments of FIGS. 5a and 5b, optional polarization control units 470 and 475 are used to control polarization states of signals 431 and 441 to satisfy system requirements if needed. Unit 400 outputs non-inverting carrier signal 401 and inverting carrier signal 402; signal 401 and signal 402 are reference signals to each other.

FIG. 13 shows an embodiment of receiving and preprocessing unit 400 where non-inverting signal path uses a heterodyne or homodyne based receiver 480 to receive input signals arriving at receiver 40, and inverting signal path uses a heterodyne or homodyne based receiver 485 to receive the input signals. Receivers 480 and 485 are tuned so that their respective output signals 401 and 402 have the same characteristic as in the embodiment of FIG. 5a.

In each and every embodiment of FIGS. 5a, 5b, and 13n non-inverting carrier signal 401 and inverting signal 402 then go through common mode noise elimination and signal conversion unit 500. Using unit 500 in FIG. 6a, signal detection and conversion unit 520 converts signal 401 into electrical signal 521 so that signal 521 matches the requirements of the non-inverting input of electrical common mode noise eliminator and optional low-noise signal amplifier 540. Meanwhile, signal detection and conversion unit 530 converts signal 402 into electrical signal 531 so that signal 531 matches the requirements of the inverting input of unit 540. Unit 540 eliminates common mode noise contained in its input signals and outputs electrical signal 541 that contains their differences. Signal 541 can either be a single-ended signal or a differential signal pair. Signal 541 can either directly go to a demodulator, or go through further processing provided by optional electrical AGC and/or limiting amplifier 560 to generate output signal 501.

Using unit 500 in FIG. 6b, signal 401 and signal 402 pass through interference-based common mode noise eliminator 510 where they destructively interfere with each other. Unit 510 also converts the result of interference into electrical output signal 511 containing the difference between signals 401 and 402. Similarly, signal 511 can either directly go to a demodulator, or go through further processing such as passing through electrical low-noise amplifier 550 followed by optional electrical AGC and/or limiting amplifier 560 to generate output signal 501.

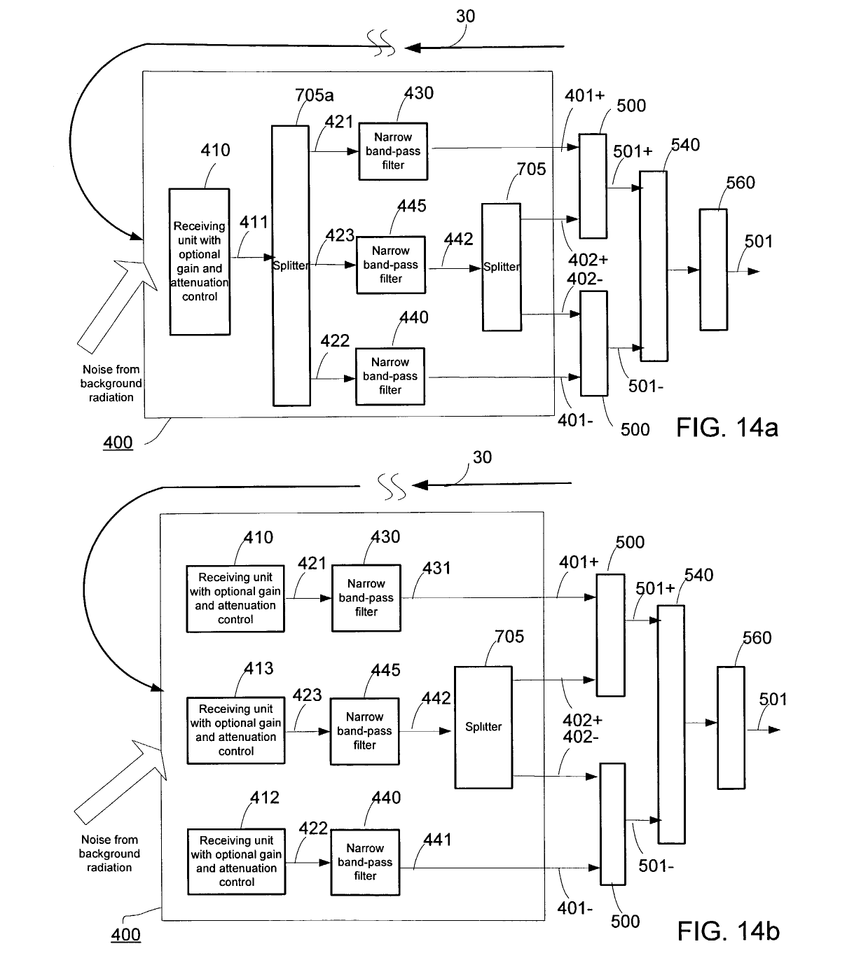

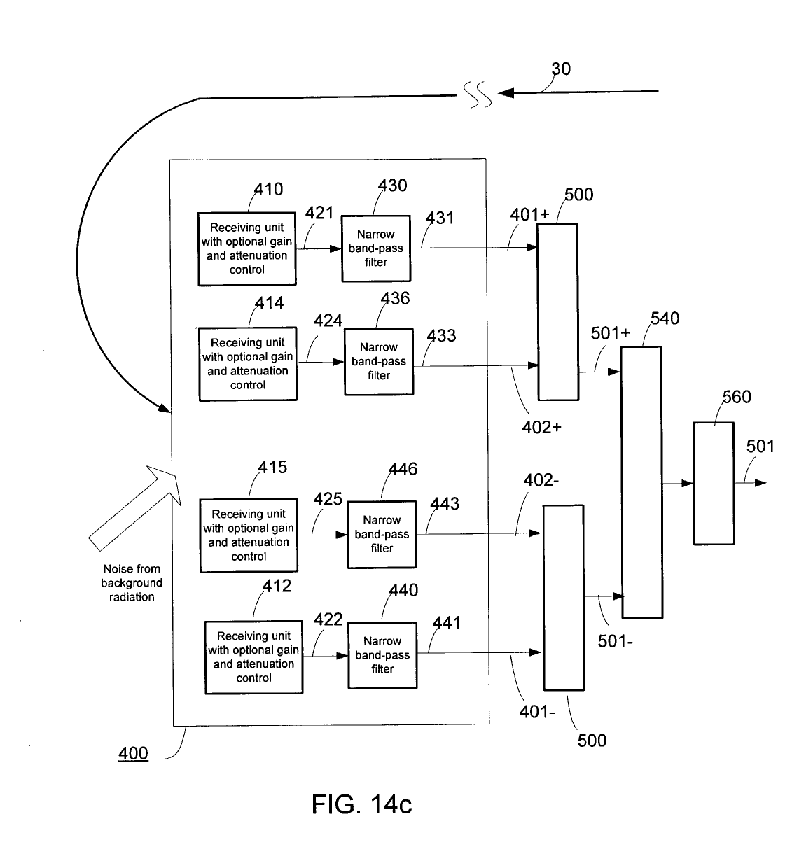

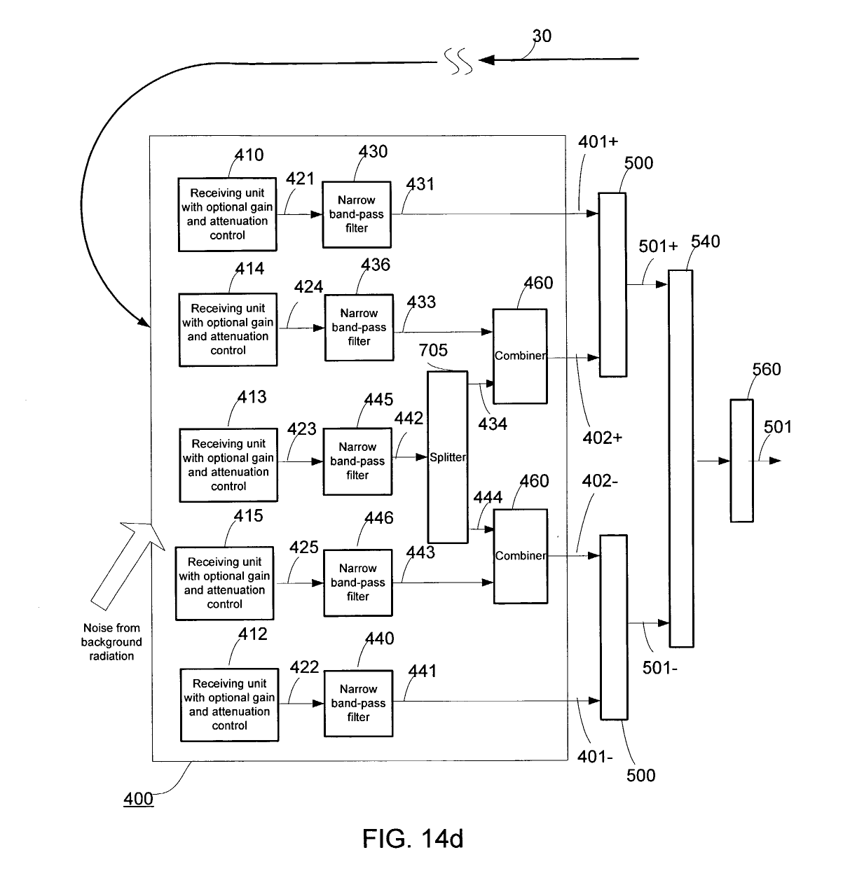

Differential signaling also enables sharing of noise reference signals. This allows wider separation between the spectrum of a non-inverting carrier signal and the spectrum of an inverting carrier signal. FIG. 14a and FIG. 14b shows two examples of embodiments that used a shared noise reference signal.

Optional delay units and polarization control units are omitted in all embodiments from FIG. 14a to FIG. 16c to avoid clutter; they should preferably be included when needs arise.

Embodiment in FIG. 14a contains three signal paths, a non-inverting signal path, an inverting signal path, and a shared noise reference signal path. All paths share receiving unit with optional gain and attenuation control 410 and splitter 705a. The non-inverting signal path further contains narrow band-pass filter 430. The inverting signal path further contains narrow band-pass filter 440. The shared reference signal path further contains narrow band-pass filter 445 and splitter 705.

Unit 410 receives desired differential signal pair along with noise from background radiation. By adjusting the gain and attenuation control, it maximizes SNR of its output signal 411 and maintains sufficient power for subsequent processing. Splitter 705a then splits signal 411 into three signals: 421, 422 and 423 so that signal 423 effectively cancels in-band noise of both signal 421 and signal 422. It can also simply split into signals 421, 422, and 423 with approximate intensity ratio 25%, 25%, and 50% respectively.

Signal 421 goes through filter 430, whose center frequency substantially equals to fₙ, the center frequency of desired non-inverting signal, and whose pass-band width is larger than wₙ, the linewidth of the non-inverting signal. This setup ensures that the output signal 401+ contains desired non-inverting signal. Signal 422 goes through filter 440, whose center frequency substantially equals to fₜ, the center frequency of desired inverting signal, and whose pass-band width is larger than wᵢ, the linewidth of the inverting signal. This setup ensures that the output signal 401− contains the inverting signal. Signal 423 goes through filter 445. Setup of filter 445 depends on the setup of filters 430 and 440. Following the example before where wₙ=wᵢ, fₙ>fᵢ, and the bandwidths of filters 430 and 440 are both substantially 2wₙ, passing bandwidth of filter 445 is then also substantially 2wₙ, and its center frequency substantially equals to fᵢ+2wₙ. The setup of these filters implicitly requires fₙ−fᵢ>=4wₙ. Signal 442, the output of filter 445, is then split into two signals 402+ and 402−, with approximately 50% and 50% intensity ratio.

Unit 400 in this embodiment has two pairs of output. The first pair comprises non-inverting carrier signal 401+ and its noise reference signal 402+. The second pair comprises inverting carrier signal 401− and its noise reference signal 402−. Signal 401+ and 402+ then pass through a first common mode noise elimination and signal conversion unit 500, and signal 401− and 402− pass through a second common mode noise elimination and signal conversion unit 500. It is required that these units either both use both use electrical common noise eliminators shown in FIG. 6a or both use interference-based common noise eliminators shown in FIG. 6b. The first unit 500 outputs noise-reduced non-inverting electrical signal 501+, and the second unit 500 outputs noise-reduced inverting electrical signal 501−.

If desired, signal 501+ and signal 501− can go through electrical common mode noise eliminator and optional low-noise signal amplification unit 540 to further eliminate noises from non-background radiation sources. In this example, unit 500 also converts differential signals into single-ended signals; alternatively it can also output differential signals. If desired optional electrical AGC and/or limiting amplifier 560 can be used to further shape the signal before passing the signal to a demodulator.

Splitting received input signals into three parts as shown in FIG. 14a may significantly waste received signal power; separately receiving reference signals can mitigate the problem. FIG. 14b shows an example where every signal path has its own receiving unit with optional gain and attenuation control. The embodiment in FIG. 14b contains three signal paths. A non-inverting signal path comprises receiving unit 410 and narrow band-pass filter 430. An inverting signal path comprises receiving unit 412 and narrow band-pass filter 440. A shared reference signal path comprises receiving unit 413, narrow band-pass filter 445, and splitter 705.

Units 410, 412, and 413 separately receive input signals arriving at receiver 40. Units 410 and 412 are preferably physically placed and tuned to maximize the SNR in their respective output signals 421 and 422. Signals 421 and 422 are preferably also tuned to have substantially equal intensity. Unit 413 is preferably tuned so that intensity of its output signal 423 is substantially equal to the sum of the intensity of in-band noise of signal 421 and the intensity of in-band noise of signal 422. All three receiving units are preferably placed close enough to each other so that background radiation affects all of them approximately equally.

Signals 421, 422, and 423 then go through filters 430, 440 and 445 respectively. Setup of filters 430, 440, and 445 and the limitation on fₙ and fᵢ follow the embodiment of FIG. 14a. Splitter 705 then splits signal 442, the output of filter 445, into two signals 402+ and 402−, with approximately 50% and 50% intensity ratio. Unit 400 of this embodiment similarly outputs two pairs of signals: signals 401+ and 402+, and signals 401− and 402−.

Also similar to the embodiment of FIG. 14a, signal 401+ and signal 402+ pass through a first common mode noise elimination and signal conversion unit 500, and generate noise-reduced non-inverting electrical signals 501+. Signal 401− and signal 402− pass through a second unit 500 and generate noise-reduced inverting electrical signals 501−. An electrical common mode noise eliminator and optional low-noise signal amplifier 540 can then be used to further reject common mode noise in 501+ and 501− if desired. An optional electrical AGC and/or limiting amplifier 560 can also be used to transform the output of unit 540 to output 501 if needed.

Not shown in figures, but similar as shown in FIG. 13, non-inverting signal path uses a first heterodyne or homodyne receiving unit 480 to replace units 410 and 430, and inverting path uses a second heterodyne or homodyne receiving unit 485 to replace unit 412 and 440. Unit 480 and 485 are set so that the center frequencies and line-widths of output signals 431 and 441 are the same as in FIG. 14b. Settings for shared noise reference signal and other devices remain the same as in the embodiment of FIG. 14b. Phase difference between signals 401+ and 402+, and phase difference between signals 401− and 402− should preferably be adjusted if needed and polarization of transmitted carrier signals should preferably be controlled through units 230 and 235 of FIG. 12 if needed.

As indicated before, using balanced reference signals can reduce noise more effectively. FIG. 14c is an embodiment of receiving and preprocessing unit 400 which uses two unshared reference signals and differential signals themselves to form balanced noise cancellation.

The embodiment has four signal paths; each path has a separate receiving unit with optional gain and attenuation control. A non-inverting signal path contains receiving unit 410 and narrow band-pass filter 430. An inverting signal path contains receiving unit 412 and narrow band-pass filter 440. A first reference signal path contains receiving unit 414 and narrow band-pass filter 436. A second reference signal path contains receiving unit 415 and narrow band-pass filter 446.

Units 410, 412, 414, and 415 separately receive desired differential signals together with noise from background radiation. Physical placement of units 410, 412, 414, and 415 satisfies the following requirements: 1) Unit 410 should preferably be placed and tuned to maximize the SNR for non-inverting signal in its output 421, and unit 412 should preferably be placed and tuned to maximize the SNR for inverting signal in its output signal 422. 2) Unit 414 is preferably placed close to unit 410 so that background radiation affects both units approximately equally. 3) Unit 415 is preferably placed close to unit 412 so that background radiation affects both units approximately equally. The relative position of units 410, 412, 414, and 415 in FIG. 14c is for the clarity of drawing; it does not reflect the placement requirement stated above. Signal intensity satisfies the following requirements: 1) Signals 421 and 422 are preferably tuned to have approximately equal intensity. 2) Intensity of signal 424 is approximately equal to a half of the intensity of in-band noise of signal 421. 3) Intensity of signal 425 is approximately equal to a half of the intensity of in-band noise of signal 422.

Signals 421, 422, 424, and 425 then respectively go through filters 430, 440, 436, and 446. Following the example in the embodiment of FIG. 5b, where wₙ=wᵢ, fₙ−fᵢ=2wₙ, the center frequency of filter 430 is substantially fₙ, center frequency of filter 440 is substantially fₜ, the bandwidths of filters 430 and 440 are both substantially 2wₙ. The passing bandwidth of filter 436 is substantially 2wₙ, and its center frequency is substantially fₙ+2wₙ. The passing bandwidth of filter 446 is substantially 2wₙ, and its center frequency is substantially fᵢ−2wₙ. The result of this setup is that output signal 431 contains the non-inverting signal plus in-band noise, output signal 441 contains the inverting signal plus in-band noise, output signal 433 is a noise reference signal for signal 431, and output signal 443 is a noise reference signal for signal 441.

Signals 431, 433, 443, and 441 may undergo more processing such as polarization selection. They can also directly undergo common mode noise elimination as shown in FIG. 14c where signal 431 becomes signal 401+, signal 433 becomes signal 402+, signal 441 becomes signal 401−, and signal 443 becomes signal 402−.

Following the same description for the embodiment of FIG. 14a, signals 401+ and 402+ pass through first common mode noise elimination and signal conversion units 500 and output a noise-reduced electrical differential signal 501+; signals 401− and 402− pass through second common mode noise elimination and signal conversion units 500 and output a noise-reduced electrical differential signal 501−. An electrical common mode noise eliminator and optional low-noise signal amplifier 540 can then used to further reject common mode noise contained in signals 501+ and 501− if desired. An optional electrical AGC and/or limiting amplifier 560 is used to reshape output of unit 540 to output 501 when needed.

Not shown in figures, but similar as shown in FIG. 13, non-inverting signal path uses a first heterodyne or homodyne receiving unit to replace units 410 and 430, and inverting path uses a second heterodyne or homodyne receiving unit to replace unit 412 and 440. The receivers are set so that the center frequencies and linewidth of output signals 431 and 441 are the same as in FIG. 14c. The settings for noise reference signals and all the other units remain the same as in the embodiment of FIG. 14c. Phase difference between signals 401+ and 402+, and phase difference between signals 401− and 402− should preferably be adjusted if required and polarization of transmitted carrier signals should preferably be controlled through units 230 and 235 of FIG. 12 if needed.

FIG. 14d shows an embodiment of receiving and preprocessing unit 400 that contains six signal paths; except shared reference paths, every other path has a separate receiving unit with optional gain and attenuation control. A non-inverting signal path contains receiving unit 410 and narrow band-pass filter 430. An inverting signal path contains receiving unit 412 and narrow band-pass filter 440. A first shared reference signal path contains receiving unit 413 and narrow band-pass filter 445, splitter 705, and a first combiner 460. A second shared reference signal path contains receiving unit 413 and narrow band-pass filter 445, splitter 705, and a second combiner 460. A first reference signal path contains receiving unit 414 and narrow bandpass filter 436. A second reference signal path contains receiving unit 415 and narrow band-pass filter 446.

The placement of units 410, 412, 414 and 415 and the intensity of signals 421, 422, 424 and 425 preferably satisfy the requirements listed in the embodiment of FIG. 14c. The placement of unit 413 and the intensity of signal 423 follow the requirements listed in the embodiment of FIG. 14b. Following the previous example, the difference between the center frequencies of information signals is substantially fₙ−fᵢ=4wₙ. Center frequency of filter 430 is substantially fₙ, center frequency of filter 440 is substantially fₜ, the bandwidths of filters 430 and 440 are both substantially 2wₙ. The passing bandwidth of filter 436 is substantially 2wₙ; its center frequency is substantially fₙ+2wₙ. The passing bandwidth of filter 446 is substantially 2wₙ; its center frequency is substantially fₜ−2wₙ. The passing bandwidth of filter 445 is substantially 2wₙ, and its center frequency is substantially fᵢ+2wₙ.

The result of this setup is that output signal 431 of filter 430 contains the non-inverting signal plus in-band noise, output signal 441 of filter 440 contains the inverting signal plus in-band noise, output signal 433 of filter 436 is a noise reference signal for signal 431, and output signal 443 of filter 446 is a noise reference signal for signal 441. Signal 442, output of filter 445, is a shared noise reference signal for both signal 431 and signal 441.

Splitter 705 then splits signal 442 into signal 434 and signal 444, with approximately equal intensity. The first combiner 460 combines signal 434 and 433 to form balanced reference signal 402+ for non-inverting signal 401+. Meanwhile, the second combiner 460 combines signal 444 and 443 to form balanced reference signal 402− for inverting signal 401−.

Same as before, signals 401+ and 402+ pass through first common mode noise elimination and signal conversion unit 500 that outputs a noise-reduced electrical signal 501+. Signals 401− and 402− pass through second common mode noise elimination and signal conversion unit 500 that outputs a noise-reduced electrical signal 501−. An electrical common mode noise eliminator and optional low-noise signal amplifier 540 can then used to further reject common mode noise contained in signals 501+ and 501− if desired. An optional electrical AGC and/or limiting amplifier 560 is used to change output of unit 540 to output 501 when needed.

Not shown in figures, but similar as shown in FIG. 13, non-inverting signal path uses heterodyne or homodyne receiving unit 480 to replace units 410 and 430, and inversion signal path uses heterodyne or homodyne receiving unit 485 to replace unit 412 and 440. Units 480 and 485 are set so that the center frequencies and linewidth of output signals 431 and 441 remain the same as in the embodiment of FIG. 14d. The settings for noise reference signals and all the other devices remain the same as in the embodiment of FIG. 14d. Phase difference between signals 401+ and 402+, and phase difference between signals 401− and 402− should preferably be adjusted if required and polarization of transmitted carrier signals should preferably be controlled through units 230 and 235 of FIG. 12 if needed.

Similar to FIG. 10 but not shown in the figures, embodiment of FIG. 14d can use two three-input common mode noise eliminators 510a in place of units 500, eliminating both combiners. Signals 431, 433 and 434 are respectively connected to input ports 401, 402, and 409 of first unit 510a. Signals 441, 443 and 444 are respectively connected to input ports 401, 402, and 409 of second unit 510a. All the other devices remain the same as in FIG. 14d.

So far embodiments presented in this section directly receive input signals that arrive at receiver 40. In the rest of this section we will describe embodiments of post frequency conversion common mode noise elimination unit 700 and 700a, which receive input from the output of a frequency conversion stage. The output of unit 700 and 700a, signal 501, can be directly sent to demodulator 600, as shown in FIGS. 1a and 1b, or go through further processing as shown in FIG. 1c.

FIGS. 15a, 15b, and 15c show the embodiments of unit 700a that takes input from the output 302 of frequency conversion stage 300a shown in FIG. 2b. Consequently, the values of center frequencies fₙ and fᵢ and linewidth wₙ and wᵢ of desired differential signal pair are now determined by the connected stage. All three embodiments contain a non-inverting signal path and an inverting signal path; they differ in reference signal paths. Each and every embodiment has a splitter shared by all of the paths of the embodiment. All non-inverting signal paths in these embodiments further contain narrow band-pass filter 430, and all inverting signal paths in these embodiments further contain narrow band-pass filter 440.

The embodiment in FIG. 15a further contains a shared noise reference signal path. The shared signal path further contains narrow band-pass filter 445 and splitter 705. Similar to the embodiment of FIG. 14a, signal 442 is then split into signal 402+ and 402−. Setup of filters 430, 440, and 445, and consequently the nature of signals 401+, 402+, 401−, and 402−, follow the description for FIG. 14a, with the exception that the values of fₙ, fᵢ, wₙ, wᵢ are now determined by the frequency conversion stage whose output is taken as input by this embodiment.

The embodiment shown in FIG. 15b further contains a first noise reference path and a second noise reference path. The first noise reference path further contains narrow band-pass filter 436, and the second noise reference path further contains narrow band-pass filter 446. Setup of filters 430, 440, 436 and 446, and consequently the nature of signals 401+, 402+, 401−, and 402−, follow the description for FIG. 14c, with the exception that the values of fₙ, fᵢ, wₙ, wₜ are now determined by the frequency conversion stage whose output is taken as input by this embodiment.

The embodiment shown in FIG. 15c further contains a first shared noise reference path, a second shared noise reference path, a first unshared noise reference path and a second unshared noise reference path. The first shared noise reference path further contains narrow band-pass filter 445, splitter 705, and a first combiner 460. The second shared noise reference path further contains narrow band-pass filter 445, splitter 705, and a second combiner 460. The first unshared noise reference path further contains narrow band-pass filter 436 and the first combiner 460. The second unshared noise reference path further contains narrow band-pass filter 446 and the second combiner 460. Setup of filters 430, 440, 445, 436 and 446, and consequently the nature of signals 401+, 402+, 401−, and 402−, follow the description for FIG. 14d, with the exception that the values of fₙ, fᵢ, wₙ, wᵢ are now determined by the frequency conversion stage whose output is taken as input by this embodiment.

The difference between embodiments in FIGS. 15a, 15b, and 15c and the embodiments in FIGS. 14a, 14b, and 14c are: 1) the embodiments in FIGS. 15a, 15b, and 15c use two interference-based common mode noise eliminators 510 for the first stage noise elimination, instead of two common mode elimination and signal conversion units 500 as in FIGS. 14a, 14b, and 14c; 2) the embodiments in FIGS. 15a, 15b, and 15c directly export the output of unit 540 as final output 501, instead of going through amplifier 560. The variation is intended to show the flexibility of unit composition.

Embodiment in FIG. 15d shows an example of how to use three-input interference-based common mode noise eliminator 510a for differential signaling. This embodiment is similar to the embodiment of FIG. 15c, except the following differences: 1) all combiners are eliminated; 2) first shared noise reference signal 434 and first unshared noise reference signal 433 are directly connected to respective input ports 402+ and 409+ of a first unit 510a; 3) second shared noise reference signal 444 and second unshared noise reference signal 443 are directly connected to respective input ports 402− and 409− of a second unit 510a. The settings of all the filters and the nature of all the signals are the same as in the embodiment of FIG. 15c.

FIGS. 16a, 16b, and 16c show the embodiments of unit 700 that takes input from the electrical output signal 301 of either frequency conversion stage 300 or 300b shown in FIG. 2a. Consequently, the values of center frequencies fₙ and fᵢ and linewidth wₙ and wₜ of desired differential signal pair are now determined by the connected stage. All three embodiments contain a non-inverting signal path and an inverting signal path. They differ in reference signal paths. Each and every embodiment has a splitter shared by all paths of the embodiment. Non-inverting signal paths of all these embodiments further contain narrow band-pass filter 430, and all inverting signal paths further contain narrow band-pass filter 440.

The embodiment shown in FIG. 16a further contains a shared noise reference signal path which further contains narrow band-pass filter 445 and splitter 705. Similar to the embodiment of FIG. 14a, signal 442 is split into signal 402+ and 402−. Setup of filters 430, 440, and 445, and consequently the nature of signals 401+, 402+, 401−, and 402−, follow the description for FIG. 14a, with the exception that the values of fₙ, fᵢ, wₙ, wᵢ are now determined by the frequency conversion stage whose output is taken as input by this embodiment.

The embodiment shown in FIG. 16b further contains two noise reference signal paths. The first noise reference signal path further contains narrow band-pass filter 436, and the second noise reference signal path further contains narrow band-pass filter 446. Setup of filters 430, 440, 436 and 446, and consequently the nature of signals 401+, 402+, 401−, and 402−, follow the description for FIG. 14c, with the exception that the values of fₙ, fᵢ, wₙ, wᵢ are now determined by the frequency conversion stage whose output is taken as input by this embodiment.

The embodiment shown in FIG. 16c further contains four noise reference signal paths. The first shared noise reference signal path further contains narrow band-pass filter 445, splitter 705, and a first combiner 460. The second shared noise reference signal path further contains narrow band-pass filter 445, splitter 705, and a second combiner 460. The first unshared noise reference signal path further contains narrow band-pass filter 436 and the first combiner 460. The second unshared noise reference signal path further contains narrow band-pass filter 446 and the second combiner 460. Setup of filters 430, 440, 445, 436 and 446, and consequently the nature of signals 401+, 402+, 401−, and 402−, follow the description for FIG. 14d, with the exception that the values of fₙ, fᵢ, wₙ, wᵢ are now determined by the frequency conversion stage whose output is taken as input by this embodiment.

The difference between embodiments in FIGS. 16a, 16b, and 16c and the embodiments in FIGS. 14a, 14b, and 14c are: 1) the embodiments in FIGS. 16a, 16b, and 16c use two electrical common mode eliminators 540 for the first stage noise elimination, instead of two common mode noise elimination and signal conversion units 500 as in FIGS. 14a, 14b, and 14c; 2) the embodiments in FIGS. 16a, 16b, and 16c directly export the output of unit 540 as final output 501, instead of going through amplifier 560. The variation is again intended to show the flexibility of unit composition.

The example shown in FIG. 9b is also applicable to systems that use differential signaling. We can setup the existing signal path in FIG. 9b for non-inverting signal, add a new path, including a new Signal+Nb unit, a new narrow band-pass filter, a new optional delay unit, and a new optional polarization control unit for inverting signal. The placement of these units and the structure of reference signal paths follow the embodiment of FIGS. 14b, 14c, or 14d depending on what reference signals are desired.

6. Variations of the Embodiments

The foregoing describes a method and system of a source-to-destination, one-dimensional communication system. A bi-directional communication system can be constructed by integrating the logic of both transmitter 20 and receiver 40 into a transceiver, and locating the transceiver in every end point of communication.

The method of this invention is applicable to systems that use electromagnetic waves in various frequency spectra for communicating information, including optical, far and near infrared, microwave, and radio wave.

Discrete representation of functional blocks in the embodiments in the figures of this document is only for clarity. It does not imply that the blocks are discrete components; nor does it imply that the boundaries between blocks are fixed or limiting. Skilled designers can integrate parts or all of the logical components into a single device. For example, demodulator 600, unit 550, 560 can be integrated into a single circuitry; demodulator 600, unit 540, 560 can be integrated into a single circuitry; unit 510 or unit 510a can be combined with unit 400 to form a single interferometer. Logic functions that implement the method can also distributed in various system components with no limit imposed by unit boundaries.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

What is claimed is:

1. A method for eliminating unwanted background radiation from a desired information signal in a communication system, comprising the steps of:
partitioning the spectrum of electromagnetic waves of interest into a plurality of spectral partitions, a signal partition and at least one reference partition, chosen such that:
said signal partition preferentially includes the energy spectrum of said information signal, and
unwanted broad-spectrum background radiation preferably affects said spectral partitions similarly,
receiving input signals so that said input signals contain said desired information,
constructing a carrier signal from said input signals so that the spectrum of said carrier signal is substantially said signal partition,
constructing a reference signal from said input signals so that the spectrum of said reference signal is substantially the union of said reference partitions, and
differencing said carrier signal and said reference signal and generating a noise-reduced output signal.

2. The method of claim 1, wherein:
said input signals are received from a communication link connecting a receiver to a transmitter,
said carrier signal and said reference signal are constructed using at least one mechanism selected from the group consisting of splitting a single signal, and combining multiple signals, and
said differencing is carried out by passing said carrier signal and said reference signal as input through a common mode noise eliminator.

3. The method of claim 1, wherein:
said input signals are received from the output of a frequency conversion stage of a receiver,
wherein said stage shifts the spectrum of its input to a desired frequency range and generates said input signals,
said carrier signal and said reference signal are constructed using at least one mechanism selected from the group consisting of splitting a single signal, and combining multiple signals, and
said differencing is carried out by passing said carrier signal and said reference signal as input through a common mode noise eliminator.

4. The method of claim 1 wherein:
said reference signal is a signal selected from the group consisting of balanced reference signals and unbalanced reference signals,
said differencing uses a mechanism based on destructive interference between said carrier signal and at least one said reference signal, and outputs a noise-reduced carrier signal, and
said differencing further including the step of:
converting said noise-reduced carrier signal into a noise-reduced electrical output signal.

5. The method of claim 4 wherein said differencing further including the step of:
adjusting the intensity of at least said reference signal so that the difference between the intensity of said carrier signal and the intensity of said reference signal is approximately equal to the intensity of a wanted signal, wherein said wanted signal is selected from the group consisting of:
a transmitted signal appeared at an entrance of a receiver, and
a transmitted signal appeared at the output of a frequency conversion stage of a receiver,
wherein said adjustment allows the intensity of said reference signal to vary from a maximum to approximately zero.

6. The method of claim 4 wherein said differencing further including the step of:
adjusting path difference between said carrier signal and said reference signal so that said path difference is smaller than the coherence length of said signals.

7. The method of claim 4 wherein said differencing further including the step of adjusting center frequency of at least said reference signal.

8. The method of claim 4, wherein said differencing comprising the steps of:
passing said carrier signal through a first medium with a first index of refraction,
passing said reference signal through a second medium with a second index of refraction, wherein:
said first index of refraction and said second index of refraction are different, and
said first medium and said second medium meet at an interference location chosen so that said carrier signal and said reference signal interfere destructively at said location and form a noise-reduced carrier signal, and
converting said noise-reduced carrier signal at said interference location to a noise-reduced electrical output signal.

9. The method of claim 4, wherein:
said reference signal comprising an upper reference signal and a lower reference signal, and
passing said carrier signal through a first medium with a first index of refraction,
passing said upper reference signal through a second medium with a second index of refraction,
passing said lower reference signal through a third medium with a third index of refraction, wherein:
said first index of refraction, said second index of refraction, and said third index of refraction are different, and
said first medium, said second medium, and said third medium meet at an interference location chosen so that said carrier signal, said upper reference signal, and said lower reference signal interfere destructively at said location and form a noise-reduced carrier signal, and
converting said noise-reduced carrier signal at said interference location to a noise-reduced electrical output signal.

10. The method of claim 1, wherein said differencing comprising the steps of:
said reference signal is a signal selected from the group consisting of balanced reference signals and unbalanced reference signals,
said differencing including the steps of:
converting said carrier signal into a first electrical signal,
converting said reference signal into a second electrical signal, and
passing said first electrical signal and said second electrical signal as input through an electrical common mode noise eliminator and generating a noise-reduced electrical output signal.

11. The method of claim 10, wherein said differencing further including the step of:
adjusting the strength of at least one of said signals so that the difference between the strength of said first electrical signal and the strength of said second electrical signal is approximately equal to the strength of the electrical signal converted from a wanted signal, wherein said wanted signal is selected from the group consisting of:
a transmitted signal appeared at an entrance of a receiver, and
a transmitted signal appeared at the output of a frequency conversion stage of a receiver,
wherein said adjustment allows the strength of said second electrical signal to vary from a maximum to approximately zero.

12. A method for using differential signaling to eliminate unwanted background radiation from information-carrying signals in a communication system, comprising the steps of:
partitioning the spectrum of electromagnetic waves of interest into a first signal partition and a second signal partition such that said spectral partitions contain unwanted broad-spectrum background radiation preferably approximately equally,
converting information input into a first modulating signal and a second modulating signal so that said modulating signals belong to a differential signal pair,
generating a first modulated signal and a second modulated signal, so that:
the spectrum of said first modulated signal is substantially said first signal partition,
the spectrum of said second modulated signal is substantially said second signal partition,
said first modulated signal is modulated by said first modulating signal, and
said second modulated signal is modulated by said second modulating signal,
transmitting said first modulated signal and said second modulated signal towards a receiver, via a communication link,
receiving input signals from said link so that said input signals contain the energy of said first modulated signal and said second modulated signal arrived at said receiver,
constructing a first carrier signal from said input signals so that the spectrum of said first carrier signal is substantially said first signal partition,
constructing a second carrier signal from said input signals so that the spectrum of said second carrier signal is substantially said second signal partition, and
differencing said first carrier signal and said second carrier signal and generating a noise-reduced output signal.

13. The method of claim 12, wherein:
said input signals are received from said communication link, and
said first carrier signal and said second carrier signal are constructed using at least one mechanism selected from the group consisting of splitting a single signal, and combining multiple signals.

14. A method of claim 12, wherein:
said input signals are received from the output of a frequency conversion stage of a receiver, wherein said stage shifts the spectrum of its input to a desired frequency range and generates said input signals, and
said first carrier signal and said second carrier signal are constructed using at least one mechanism selected from the group consisting of splitting a single signal, and combining multiple signals.

15. The method of claim 12, wherein said differencing comprising the steps of:
converting said first carrier signal into a first electrical signal,
converting said second carrier signal into a second electrical signal, and
passing said first electrical signal and said second electrical signal through an electrical common mode noise eliminator and generating a noise-reduced electrical output signal.

16. The method of claim 15, wherein said differencing further including the step of:
adjusting the strength of at least one of said signals so that strength of said first electrical signal approximately equals to the strength of said second electrical signal.

17. The method of claim 12 wherein:
said differencing uses a mechanism based on destructive interference between said first carrier signal and said second carrier signal, and outputs a noise-reduced carrier signal, and
said differencing further including the step of:
converting said noise-reduced carrier signal into a noise-reduced electrical output signal.

18. The method of claim 17 wherein said differencing further including the step of:
adjusting the intensity of at least one of said carrier signals so that the intensity of said first carrier signal is approximately equal to the intensity of said second carrier signal.

19. The method of claim 17 wherein said differencing further including the step of:
adjusting path difference between said first carrier signal and said second carrier signal so that said path difference is smaller than the coherence length of said carrier signals.

20. The method of claim 17 wherein said differencing further including the step of:
adjusting center frequency of at least one said carrier signal.

21. The method of claim 17, wherein said differencing comprising the steps of:
passing said first carrier signal through a first medium with a first index of refraction,
passing said second carrier signal through a second medium with a second index of refraction, wherein:
said first index of refraction is different than said second index of refraction, and
said first medium and said second medium meet at an interference location chosen so that said first carrier signal and said second carrier signal interfere destructively at said location and form a noise-reduced carrier signal,
converting said noise-reduced carrier signal at said interference location to a noise-reduced electrical output signal.

22. The method of claim 12, wherein:
said spectral partitions further including a shared partition so that:
said shared partition is intermediate between said first signal partition and said second signal partition, and is chosen so as to preferentially exclude both energy spectrum of said first carrier signal and energy spectrum of said second carrier signal, and
said method further including the step of:
constructing a shared reference signal from said input signals so that the spectrum of said shared reference signal is substantially said shared partition.

23. The method of claim 22, wherein said differencing comprising the steps of:
converting said shared reference signal into a first shared electrical reference signal and a second shared electrical reference signal, so that:
said first shared electrical reference signal is preferably obtained from substantially a first half of said shared reference signal, and
said second shared electrical reference signal is preferably obtained from substantially a second half of said shared reference signal,
converting said first carrier signal into a first electrical signal,
converting said second carrier signal into a second electrical signal,
passing said first electrical signal and said first shared electrical reference signal through a first electrical common mode noise eliminator and outputting a first noise-reduced electrical signal,
passing said second electrical signal and said second shared electrical reference signal through a second electrical common mode noise eliminator and outputting a second noise-reduced electrical signal, and
passing said first noise-reduced electrical signal and said second noise-reduced electrical signal through a third electrical common mode noise eliminator and outputting a noise-reduced electrical output signal.

24. The method of claim 22, wherein said differencing comprising the steps of:
splitting said shared reference signal into a first shared reference signal and a second shared reference signal,
passing said first carrier signal and said first shared reference signal through a first interference-based common mode noise eliminator and outputting a first noise-reduced electrical signal,
passing said second carrier signal and said second shared reference signal through a second interference-based common mode noise eliminator and outputting a second noise-reduced electrical signal, and
passing said first noise-reduced electrical signal and said second noise-reduced electrical signal through a third electrical common mode noise eliminator and outputting a noise-reduced electrical output signal.

25. The method of claim 12, wherein:
said first signal partition preferably resides in a higher frequency range than said second signal partition,
said spectral partitions further including an upper partition and a lower partition so that:
the spectrum of said upper partition is above the spectrum of said first signal partition, and is chosen so as to preferentially exclude both energy spectrum of said first carrier signal and energy spectrum of said second carrier signal,
the spectrum of said lower partition is below the spectrum of said second signal partition, and is chosen so as to preferentially exclude both energy spectrum of said first carrier signal and energy spectrum of said second carrier signal, and
said method further including the steps consisting of:
constructing an upper reference signal from said input signals so that the spectrum of said upper reference signal is substantially said upper partition, and
constructing a lower reference signal from said input signals so that the spectrum of said lower reference signal is substantially said lower partition,
wherein said upper reference signal and said lower reference signal are constructed using at least one mechanism selected from the group consisting of splitting a single signal, and combining multiple signals.

26. The method of claim 25, wherein said differencing comprising the steps of:
converting said first carrier signal into a first electrical signal,
converting said second carrier signal into a second electrical signal,
converting said upper reference signal into a first electrical reference signal,
converting said lower reference signal into a second electrical reference signal,
passing said first electrical signal and said first electrical reference signal through a first electrical common mode noise eliminator and outputting a first noise-reduced electrical signal,
passing said second electrical signal and said second electrical reference signal through a second electrical common mode noise eliminator and outputting a second noise-reduced electrical signal, and
passing said first noise-reduced electrical signal and said second noise-reduced electrical signal through a third electrical common mode noise eliminator and outputting said noise-reduced electrical output signal.

27. The method of claim 25, wherein said differencing comprising the steps of:
passing said first carrier signal and said upper reference signal through a first interference-based common mode-noise eliminator and outputting a first noise-reduced electrical signal,
passing said second carrier signal and said lower reference signal through a second interference-based common mode noise eliminator and outputting a second noise-reduced electrical signal, and
passing said first noise-reduced electrical signal and said second noise-reduced electrical signal through an electrical common mode noise eliminator and outputting a noise-reduced electrical output signal.

28. The method of claim 25, wherein:
said spectral partitions further including a shared partition so that:
said shared partition is intermediate between said first signal partition and said second signal partition, and is chosen so as to preferentially exclude both energy spectrum of said first carrier signal and energy spectrum of said second carrier signal, and
said method further including the step of:
constructing a shared reference signal from said input signals so that the spectrum of said shared reference signal is substantially said shared partition.

29. The method of claim 28, wherein said differencing comprising the steps of:
converting said first carrier signal into a first electrical signal,
converting said second carrier signal into a second electrical signal,
converting said upper reference signal, said lower reference signal, and said shared reference signal into a first electrical reference signal and a second electrical reference signal, so that:
said first electrical reference signal is preferably obtained from said upper reference signal and substantially a first half of said shared reference signal, and
said second electrical reference signal is preferably obtained from said lower reference signal and substantially a second half of said shared reference signal,
passing said first electrical signal and said first electrical reference signal through a first electrical common mode noise eliminator and outputting a first noise-reduced electrical signal,
passing said second electrical signal and said second electrical reference signal through a second electrical common mode noise eliminator and outputting a second noise-reduced electrical signal, and
passing said first noise-reduced electrical signal and said second noise-reduced electrical signal through a third electrical common mode noise eliminator and outputting said noise-reduced electrical output signal.

30. The method of claim 28, wherein said differencing comprising the steps of:
splitting said shared reference signal into a first shared reference signal and a second shared reference signal,
combining said upper reference signal and said first shared reference signal into a first balanced reference signal,
combining said lower reference signal and said second shared reference signal into a second balanced reference signal,
passing said first carrier signal and said first balanced reference signal through a first interference-based common mode noise eliminator and outputting a first noise-reduced electrical signal,
passing said second carrier signal and said second balanced reference signal through a second interference-based common mode noise eliminator and outputting a second noise-reduced electrical signal, and
passing said first noise-reduced electrical signal and said second noise-reduced electrical signal through an electrical common mode noise eliminator and outputting a noise-reduced electrical output signal.

31. The method of claim 28, wherein said differencing comprising the steps of:
splitting said shared reference signal into a first shared reference signal and a second shared reference signal,
passing said first carrier signal, said upper reference signal, and said first shared reference signal through a first three-input interference-based common mode noise eliminator and outputting a first noise-reduced electrical signal,
passing said second carrier signal, said lower reference signal, and said second shared reference signal through a second three-input interference-based common mode noise eliminator and outputting a second noise-reduced electrical signal, and
passing said first noise-reduced electrical signal and said second noise-reduced electrical signal through an electrical common mode noise eliminator and outputting a noise-reduced electrical output signal.

32. A receiver of a communication system for eliminating noise from background radiation contained in a desired information signal, comprising:
an information signal path for receiving desired input and outputting a carrier signal so that said carrier signal preferentially includes the energy spectrum of desired information signal,
a reference signal path for receiving said desired input and outputting a reference signal so that said reference signal can effectively cancel in-band noise of said carrier signal through common mode noise elimination, and
a common mode noise elimination unit for taking said carrier signal and said reference signal as input, eliminating common mode noise from its input, and outputting a noise-reduced output signal.

33. The receiver in claim 32, wherein:
said desired input comprises input signals arrived at said receiver from a communication link,
said information signal path contains at least one device selected from the group consisting of receiving units with optional gain and attenuation controls, splitters, combiners, band-pass filters, heterodyne-based receivers, and homodyne-based receivers, and
said reference signal path contains at least one device selected from the group consisting of receiving units with gain and attenuation controls, splitters, combiners, and band-pass filters.

34. The receiver in claim 32 further including:
a receiving unit with optional gain and attenuation control for receiving input signals arriving at said receiver from a communication link,
at least one frequency conversion stage for taking the output of said receiving unit as input, shifting the spectrum of its input to a desired frequency range, and outputting said desired input,
said information signal path contains at least one device selected from the group consisting of splitters, combiners, and band-pass filters, and
said reference signal path contains at least one device selected from the group consisting of splitters, combiners, and band-pass filters.

35. The receiver in claim 32, wherein said common mode noise elimination unit containing:
a first signal detection and conversion unit for taking said carrier signal as input and converting its input into a first electrical signal,
a second signal detection and conversion unit for taking said reference signal as input and converting its input into a second electrical signal, and
an electrical common mode noise eliminator for taking said first electrical signal and said second electrical signal as input, eliminating common mode noise from its input, and outputs said noise-reduced electrical output signal, wherein examples of said common mode noise eliminator includes differential amplifiers and instrumentation amplifiers.

36. The receiver in claim 35 further including mechanisms for adjusting signal strength along at least one said signal path so that the strength of said second electrical signal can vary from zero to approximately equal to the strength of in-band noise of said first electrical signal.

37. The receiver in claim 32, wherein said common mode noise elimination unit containing:
an interference-based common mode noise cancellation device for taking said carrier signal and said reference signal as input, eliminating common mode noise from its input through destructive interference, and outputting a noise-reduced carrier signal, and
a signal detection and conversion unit for converting said noise-reduced carrier signal into a noise-reduced electrical output signal.

38. The receiver of 37, wherein said signal paths provides at least one mechanism selected from the group consisting of:
a mechanism for adjusting the intensity of at least said reference signal,
a mechanism for controlling the polarization state of at least said reference signal,
a mechanism for adjusting path difference between said carrier signal and said reference signal, and
a mechanism for adjusting center frequency of at least said reference signal, so that said reference signal can effectively cancel in-band noise of said carrier signal.

39. The receiver of 32, wherein said common mode noise elimination unit containing:
a first medium with a first index of refraction for propagating said carrier signal,
a second medium with a second index of refraction for propagating said reference signal,
said first index of refraction and said second index of refraction are different,
said first medium and said second medium meet at an interference location chosen such that said carrier signal and said reference signal interfere destructively at said interference location and form a noise-reduced carrier signal,
a signal detection and conversion unit placed at said interference location for converting said noise-reduced carrier signal into a noise-reduced electrical output signal.

40. The receiver of 32, wherein:
said reference signal comprises an upper reference signal and a lower reference signal, and
said common mode noise elimination unit containing:
a first medium with a first index of refraction for propagating said carrier signal,
a second medium with a second index of refraction for propagating said upper reference signal,
a third medium with a third index of refraction for propagating said lower reference signal,
said first index of refraction, said second index of refraction, and said third index of refraction are different,
said first medium, said second medium, and said third medium meet at an interference location chosen such that said carrier signal, said upper reference signal, and said lower reference signal interfere destructively at said interference location and form a noise-reduced carrier signal, and
a signal detection and conversion unit placed at said interference location for converting said noise-reduced carrier signal into a noise-reduced electrical output signal.

41. A receiver of a communication system for eliminating noise from background radiation contained in a differential information signal consisting of a first information signal and a second information signal, said receiver comprising:
a first signal path for receiving desired input and outputting a first carrier signal so that said first carrier signal preferentially includes the energy spectrum of said first information signal,
a second signal path for receiving said desired input and outputting a second carrier signal so that said second carrier signal preferentially includes the energy spectrum of said second information signal, and
a common mode noise elimination unit for taking said first carrier signal and said second carrier signal as input, eliminating common mode noise from its input, and outputting a noise-reduced output signal.

42. The receiver in claim 41, wherein:
said desired input comprises input signals arrived at said receiver from a communication link,
said first signal path contains at least one device selected from the group consisting of receiving units with optional gain and attenuation controls, splitters, combiners, band-pass filters, heterodyne-based receivers, and homodyne-based receivers, and
said second signal path contains at least one device selected from the group consisting of receiving units with optional gain and attenuation controls, splitters, combiners, band-pass filters, heterodyne-based receivers, and homodyne-based receivers.

43. The receiver in claim 41 further including:
a receiving unit with optional gain and attenuation control for receiving input signals arriving at said receiver from a communication link,
at least one frequency conversion stage for taking the output of said receiving unit as input, shifting the spectrum of its input to a desired frequency range, and outputting said desired input,
said first signal path contains at least one device selected from the group consisting of splitters, combiners, and band-pass filters, and
said second signal path contains at least one device selected from the group consisting of splitters, combiners, and band-pass filters.

44. The receiver in claim 41, wherein said common mode noise elimination unit containing:
a first signal detection and conversion unit for converting said first carrier signal into a first electrical signal,
a second signal detection and conversion unit for converting said second carrier signal into a second electrical signal, and
an electrical common mode noise eliminator for taking said first electrical signal and said first electrical reference signal as input and outputting a first noise-reduced electrical signal.

45. The receiver in claim 44 further including mechanisms for adjusting signal strength along at least one said signal path so that the strength of said first electrical signal is approximately equal to the strength of said second electrical signal.

46. The receiver in claim 41, wherein said common mode noise elimination unit containing:
an interference-based common mode noise cancellation device for taking said first carrier signal and said second carrier signal as input, eliminating common mode noise from its input through destructive interference, and outputting a noise-reduced carrier signal, and
a signal detection and conversion unit for converting said noise-reduced carrier signal into a noise-reduced electrical output signal.

47. The receiver of 46, wherein said signal paths provides at least one mechanism selected from the group consisting of:
a mechanism for adjusting the intensity of at least one of said carrier signal,
a mechanism for adjusting path difference between said carrier signals,
a mechanism for adjusting center frequency of at least one of said carrier signals, and
a mechanism for controlling the polarization state of at least one said carrier signals,
so that in-band noise of said carrier signals can effectively cancel each other.

48. The receiver of 41, wherein said common mode noise elimination unit containing:
a first medium with a first index of refraction for propagating said first carrier signal,
a second medium with a second index of refraction for propagating said second carrier signal,
said first index of refraction and said second index of refraction are different,
said first medium and said second medium meet at an interference location chosen such that said first carrier signal and said second carrier signal interfere destructively at said interference location and form a noise-reduced carrier signal, and
a signal detection and conversion unit placed at said interference location for converting said noise-reduced carrier signal into a noise-reduced electrical output signal.

49. The receiver in claim 41 further including:
a shared noise reference path for receiving said desired input and outputting a shared reference signal constructed so that:
center frequency of said shared reference signal is in between center frequency of said first carrier signal and center frequency of said second carrier signal, and
said shared reference signal can effectively cancel both in-band noise of said first carrier signal and in-band noise of said second carrier signal through common mode noise elimination, and
said shared noise reference path containing at least one device selected from the group consisting of receiving units with optional gain and attenuation controls, splitters, combiners, and band-pass filters.

50. The receiver in claim 49 wherein said common mode noise elimination unit containing:
a component for converting said shared reference signal into a first electrical reference signal and a second electrical reference signal, wherein said component contains at least one of the devices selected from the group consisting of signal detection and conversion units and splitters,
a first signal detection and conversion unit for converting said first carrier signal into a first electrical signal,
a second signal detection and conversion unit for converting said second carrier signal into a second electrical signal,
a first electrical common mode noise eliminator for taking said first electrical signal and said first electrical reference signal as input and outputting a first noise-reduced electrical signal,
a second electrical common mode noise eliminator for taking said second electrical signal and said second electrical reference signal as input and outputting a second noise-reduced electrical signal, and
a third electrical common mode noise eliminator for taking said first noise-reduced electrical signal and said second noise-reduced electrical signal as input and outputting a noise-reduced electrical output signal.

51. The receiver in claim 49 wherein said common mode noise elimination unit containing:
a splitter for splitting said shared reference signal into a first reference signal and a second reference signal,
a first interference-based common mode noise eliminator for taking said first carrier signal and said first reference signal as input, and outputting a first noise-reduced electrical signal,
a second interference-based common mode noise eliminator for taking said second carrier signal and said second reference signal as input, and outputting a second noise-reduced electrical signal, and
an electrical common mode noise eliminator for taking said first noise-reduced electrical signal and said second noise-reduced electrical signal as input and outputting a noise-reduced electrical output signal.

52. The receiver in claim 41, wherein:
center frequency of said first carrier signal is preferably higher than center frequency of said second carrier signal, and
said receiver further including:
a first noise reference path for receiving said desired input and outputting a first unshared reference signal so that:
center frequency of said first unshared reference signal is higher than center frequency of said first carrier signal, and
said first unshared reference signal can effectively cancel in-band noise of said first carrier signal through common mode noise elimination,
wherein said first noise reference path containing at least one device selected from the group consisting of receiving units with optional gain and attenuation controls, splitters, combiners, and band-pass filters,
a second noise reference path for receiving said desired input and outputting a second unshared reference signal so that:
center frequency of said second unshared reference signal is lower than center frequency of said second carrier signal, and
said second unshared reference signal can effectively cancel in-band noise of said second carrier signal through common mode noise elimination,
wherein said second noise reference path containing at least one device selected from the group consisting of receiving units with optional gain and attenuation controls, splitters, combiners, and band-pass filters.

53. The receiver in claim 52 wherein said common mode noise elimination unit containing:
a first signal detection and conversion unit for converting said first carrier signal into a first electrical signal,
a second signal detection and conversion unit for converting said second carrier signal into a second electrical signal,
a third signal detection and conversion unit for converting said first unshared reference signal into a first electrical reference signal,
a fourth signal detection and conversion unit for converting said second unshared reference signal into a second electrical reference signal,
a first electrical common mode noise eliminator for taking said first electrical signal and said first electrical reference signal as input and outputting a first noise-reduced electrical signal,
a second electrical common mode noise eliminator for taking said second electrical signal and said second electrical reference signal as input and outputting a second noise-reduced electrical signal, and
a third electrical common mode noise eliminator for taking said first noise-reduced electrical signal and said second noise-reduced electrical signal as input and outputting a noise-reduced electrical output signal.

54. The receiver in claim 52 wherein said common mode noise elimination unit containing:
a first interference-based common mode noise eliminator for taking said first carrier signal and said first unshared reference signal as input, and outputting a first noise-reduced electrical signal,
a second interference-based common mode noise eliminator for taking said second carrier signal and said second unshared reference signal as input, and outputting a second noise-reduced electrical signal, and
an electrical common mode noise eliminator for taking said first noise-reduced electrical signal and said second noise-reduced electrical signal as input and outputting a noise-reduced electrical output signal.

55. The receiver in claim 52 further including:
a shared noise reference path for receiving said desired input and outputting a shared reference signal constructed so that:
center frequency of said shared reference signal is in between center frequency of said first carrier signal and center frequency of said second carrier signal, and
said shared reference signal can effectively cancel both in-band noise of said first carrier signal and in-band noise of said second carrier signal through common mode noise elimination, and
said shared noise reference path containing at least one device selected from the group consisting of receiving units with optional gain and attenuation controls, splitters, combiners, and band-pass filters.

56. The receiver in claim 55 wherein said common mode noise elimination unit containing:
a component for taking said shared reference signal, said first unshared reference signal, and said second unshared reference signal as input, and outputting a first balanced electrical reference signal, and a second balanced electrical reference signal, so that:
said first balanced electrical reference signal preferably contains electrical form of components from both said first unshared reference signal and approximately a first half of said shared reference signal, and
said second balanced electrical reference signal preferably contains electrical form of components of both said second unshared reference signal and approximately a second half of said shared reference signal,
wherein said component contains at least one of the devices selected from the group consisting of splitters, combiners and signal detection and conversion units,
a first signal detection and conversion unit for converting said first carrier signal into a first electrical signal,
a second signal detection and conversion unit for converting said second carrier signal into a second electrical signal,
a first electrical common mode noise eliminator for taking said first electrical signal and said first balanced electrical reference signal as input and outputting a first noise-reduced electrical signal,
a second electrical common mode noise eliminator for taking said second electrical signal and said second balanced electrical reference signal as input and outputting a second noise-reduced electrical signal, and
a third electrical common mode noise eliminator for taking said first noise-reduced electrical signal and said second noise-reduced electrical signal as input and outputting a noise-reduced electrical output signal.

57. The receiver in claim 55 wherein said common mode noise elimination unit containing:
a splitter for splitting said shared reference signal into a first shared reference signal and a second shared reference signal,
a first combiner for combining said first shared reference signal and said first unshared reference signal into a first balanced reference signal,
a second combiner for combining said second shared reference signal and said second unshared reference signal into a second balanced reference signal,
a first interference-based common mode noise eliminator for taking said first carrier signal and said first balanced reference signal as input, and outputting a first noise-reduced electrical signal,
a second interference-based common mode noise eliminator for taking said second carrier signal and said second balanced reference signal as input, and outputting a second noise-reduced electrical signal, and
an electrical common mode noise eliminator for taking said first noise-reduced electrical signal and said second noise-reduced electrical signal as input and outputting said a noise-reduced electrical output signal.

58. The receiver in claim 55 wherein said common mode noise elimination unit containing:
a splitter for splitting said shared reference signal into a first shared reference signal and a second shared reference signal,
a first three-input interference-based common mode noise eliminator for taking said first carrier signal, said first shared reference signal, and said first unshared reference signal as input, and outputting a first noise-reduced electrical signal,
a second three-input interference-based common mode noise eliminator for taking said second carrier signal, said second shared reference signal, and said second unshared reference signal as input, and outputting a second noise-reduced electrical signal, and
an electrical common mode noise eliminator for taking said first noise-reduced electrical signal and said second noise-reduced electrical signal as input and outputting said a noise-reduced electrical output signal.

59. A transmitter for using differential signaling to eliminate noise from background radiation in a communication system, comprising:
an information signal preprocessing unit for providing a mechanism to accept information input and means for transforming said input to a first information signal and a second information signal when needed, so that said first information signal and said second information signal form a differential signal pair,
a first carrier generation and modulation unit for generating a first carrier signal so that said first carrier signal is modulated by said first information signal,
a second carrier generation and modulation unit for generating a second carrier signal so that said second carrier signal is modulated by said second information signal, and
an transmitting unit for taking outgoing signals as input, and transmitting said outgoing signals towards a receiver, via a communication link, wherein said outgoing signals contain said first carrier signal and said second carrier signal.

60. A method for using a shared reference to eliminate unwanted background radiation from a plurality of information-carrying signals in a communication system, comprising the steps of:
partitioning the spectrum of electromagnetic waves of interest into a shared partition and N signal partitions wherein N is an integer and N>1, so that for all i wherein 1=<i<=N:
i^{th} signal partition preferentially includes the energy spectrum of i^{th} information signal, and
said spectral partitions contains unwanted broad-spectrum background radiation preferably approximately equally,
constructing N carrier signals from input signals so that the spectrum of i^{th} carrier signal, is substantially said i^{th} signal partitions, for all i wherein 1=<i<=N,
splitting said shared reference signal into N reference signals, and
passing said i^{th} carrier signal and said i^{th} reference signal through an i^{th} common mode noise eliminator and outputs an i^{th} noise-reduced output signal, for all i wherein 1=<i<=N.
